(19) United States
(12) Patent Application Publication
(10) Pub. No.: US 2026/0186329 A1
(43) Pub. Date: Jul. 2, 2026

(54) OPTICAL DEVICE AND HEAD MOUNTED DISPLAY

(71) Applicant: FUJIFILM Corporation, Tokyo (JP)

(72) Inventors: Takashi YONEMOTO, Minamiashigara-shi (JP); Mayumi NOJIRI, Minamiashigara-shi (JP); Hiroshi SATO, Minamiashigara-shi (JP)

(73) Assignee: FUJIFILM Corporation, Tokyo (JP)

(21) Appl. No.: 19/547,725

(22) Filed: Feb. 24, 2026

Related U.S. Application Data
(63) Continuation of application No. PCT/JP2024/034656, filed on Sep. 27, 2024.

(30) Foreign Application Priority Data
Sep. 29, 2023 (JP) 2023-169747

(51) Int. Cl. G02F 1/01; G02B 27/01

(52) U.S. Cl. CPC G02F 1/0136; G02B 27/0172

(57) ABSTRACT

An object is to provide an optical device which can obtain an image having stable image quality regardless of a focal length in a case where a focal length of the image is changed in HMD or the like, and to provide an HMD using the optical device. The object is achieved by including a switching element which is configured to switch between a first phase difference and a second phase difference, and a difference between the first phase difference and the second phase difference is 275±20 nm at a wavelength of 550 nm, and a liquid crystal layer which is formed of a liquid crystal composition containing a liquid crystal compound having reverse wavelength dispersibility, and has a liquid crystal alignment pattern in which an orientation of an optical axis derived from the liquid crystal compound changes while continuously rotating in at least one in-plane direction.

### CROSS-REFERENCE TO RELATED APPLICATIONS

This application is a Continuation of PCT International Application No. PCT/JP2024/034656 filed on Sep. 27, 2024, which claims priority under 35 U.S.C. § 119(a) to Japanese Patent Application No. 2023-169747 filed on Sep. 29, 2023. The above applications are hereby expressly incorporated by reference, in their entirety, into the present application.

### BACKGROUND OF THE INVENTION

### 1. Field of the Invention

The present invention relates to an optical device used in a head mounted display or the like, and a head mounted display including the optical device.

### 2. Description of the Related Art

As means for providing virtual reality (VR), augmented reality (AR), or mixed reality (MR) to users, devices such as head mounted displays (HMD) have been known.

The HMD which is relatively small and easy to carry and wear has been expected as a multifunctional device which replaces a smartphone, a tablet, and the like.

In the HMD, for example, in a VR display apparatus, a half mirror and a reflective polarizer are used for reflecting an optical path of light (image) emitted from an image display apparatus to the user, so that an optical path length is increased and the user recognizes the sense of perspective of the image.

In addition, in the optical device, for example, a half mirror and a reflective polarizer are attached to a lens such as a convex lens, and light is collected by the lens to widen a field of view (FOV).

In the HMD, U.S. Pat. No. 10,379,419B discloses that a focal length of an optical system in the HMD is dynamically changed by using a switchable half waveplate (SHWP) and a plurality of liquid crystal (LC) lenses, and a distance from the user to an observation image is controlled.

In the HMD disclosed in U.S. Pat. No. 10,379,419B, for example, a switching unit including the switchable half waveplate and the liquid crystal lenses is disposed between an optical system constituting the HMD and an observation position of the image by the user.

The switchable half waveplate is a half waveplate which can be switched between an on state in which it functions as a halfwave plate and an off state in which it does not act on incident light and allows the incident light to pass therethrough as it is.

In addition, as is well known, the liquid crystal lens is a liquid crystal diffraction grating having a concentric (radial) liquid crystal alignment pattern in which an optical axis derived from a liquid crystal compound continuously rotates in one direction. The liquid crystal lens converges or diverges incident light depending on whether the incident light is dextrorotatory circularly polarized light or levorotatory circularly polarized light. Specifically, the liquid crystal lens which converges dextrorotatory circularly polarized light diverges levorotatory circularly polarized light, and the liquid crystal lens which converges levorotatory circularly polarized light diverges dextrorotatory circularly polarized light.

As an example, in the HMD, a case where an optical system upstream of the switching unit emits dextrorotatory circularly polarized light and the liquid crystal lens of the switching unit converges dextrorotatory circularly polarized light will be described.

In the configuration, in a case where the switchable half waveplate is off, that is, does not act as the half waveplate, the light is incident on the liquid crystal lens as the dextrorotatory circularly polarized light, and a focal point of the image displayed by the HMD is located at a position at which the light is collected by the liquid crystal lens of the switching unit.

On the other hand, in the switching unit, in a case where the switchable half waveplate is on, that is, acts as the half waveplate, the light transmitted through the switchable half waveplate is converted into levorotatory circularly polarized light. As described above, since the liquid crystal lens of the switching unit converges dextrorotatory circularly polarized light, the levorotatory circularly polarized light is diverged. Therefore, in this case, the light is diverged by the switching unit (liquid crystal lens), and the focal length of the display image by the HMD is longer than the focal length in a case where the switchable half waveplate is off. That is, in this state, the position of the display image is closer to the user's eye.

As the liquid crystal lens, various liquid crystal lenses are known.

For example, J.Escuti et al., Achromatic diffraction from polarization gratings with high efficiency, OPTICS LETTERS Vol. 33, No. 20, pp. 2287-2289 (Oct. 15, 2008) discloses a liquid crystal lens in which two liquid crystal layers are laminated to improve a diffraction efficiency and to widen a wavelength range in which the liquid crystal lens acts as a lens.

The liquid crystal layer constituting the liquid crystal lens is a diffraction grating (PG) having, as in the liquid crystal lens, a liquid crystal alignment pattern in which an optical axis derived from a liquid crystal compound continuously rotates in one direction, and the liquid crystal compound is twisted and aligned in a helical shape in a thickness direction (chiral PG). In the liquid crystal lens of J.Escuti et al., Achromatic diffraction from polarization gratings with high efficiency, OPTICS LETTERS Vol. 33, No. 20, pp. 2287-2289 (Oct. 15, 2008), by laminating liquid crystal layers in which the twisted directions of the liquid crystal compounds in the thickness direction are opposite to each other, the diffraction efficiency is improved, and the wavelength range in which the liquid crystal lens acts as a lens can be widened.

### SUMMARY OF THE INVENTION

As disclosed in U.S. Pat. No. 10,379,419B, by combining the HMD with the switching unit including the switchable half waveplate and the liquid crystal lens, the focal length of the optical system of the HMD can be dynamically changed, and thus the distance from the user to the observation image can be controlled. As a result, the user of the HMD can bring the convergence distance and the accommodation distance of the eyes close to each other, thereby enabling natural stereoscopic viewing. Consequently, VR sickness can be prevented.

However, according to the studies of the present inventors, in the switching unit using the conventional switchable half waveplate and the liquid crystal lens, for example, in a case where the focal length of the image is switched in the HMD or the like, problems may occur in that image quality fluctuates depending on the focal length.

An object of the present invention is to solve such a problem of the related art, and to provide an optical device which can obtain an image having stable image quality regardless of a focal length in a case where a focal length of a display image is changed in, for example, HMD or the like, and to provide an HMD using the optical device.

In order to achieve the above-described object, the present invention has the following configurations.

[1] An optical device comprising:
a switching element; and
a liquid crystal layer,
in which the switching element is an element which is configured to switch between a first phase difference and a second phase difference, and a difference between the first phase difference and the second phase difference is 275±20 nm at a wavelength of 550 nm, and
the liquid crystal layer is formed of a liquid crystal composition containing a liquid crystal compound having reverse wavelength dispersibility, and has a liquid crystal alignment pattern in which an orientation of an optical axis derived from the liquid crystal compound changes while continuously rotating in at least one in-plane direction.

[2] The optical device according to [1],
in which, in the liquid crystal alignment pattern, in a case where a length over which the orientation of the optical axis derived from the liquid crystal compound rotates by 180° in the plane is set as a single period, the liquid crystal alignment pattern has, in the plane, a region where a length of the single period varies.

[3] The optical device according to [1] or [2],
in which the liquid crystal alignment pattern has a plurality of rings having different sizes, which are arranged in the plane such that larger rings successively encompass smaller rings.

[4] The optical device according to [3],
in which the liquid crystal alignment pattern has a concentric circle shape.

[5] The optical device according to any one of [1] to [4],
in which the switching element is composed of a liquid crystal cell.

[6] A head mounted display comprising:
the optical device according to any one of [1] to [5].

[7] The head mounted display according to [6],
in which the head mounted display is any one of a virtual reality image display apparatus or an augmented reality image display apparatus.

[8] The head mounted display according to [7],
in which the head mounted display is a virtual reality image display apparatus including a light-converging optical system, and the optical device is provided downstream of the light-converging optical system.

[9] The head mounted display according to [7] or [8],
in which the head mounted display is an augmented reality image display apparatus including a light guide plate, and the optical device is provided downstream of the light guide plate.

According to the present invention, for example, in a case where a focal length of a display image is changed in HMD or the like, an image having stable image quality can be obtained regardless of the focal length.

### BRIEF DESCRIPTION OF THE DRAWINGS

FIG. 1 is a view conceptually showing an example of a VR image display apparatus according to an embodiment of the present invention.

FIG. 2 is a plan view conceptually showing an example of a liquid crystal lens.

FIG. 3 is a partially cross-sectional view conceptually showing the liquid crystal lens shown in FIG. 2.

FIG. 4 is a plan view for describing the polarization diffraction element shown in FIG. 2.

FIG. 5 is a conceptual view for describing the action of the polarization diffraction element shown in FIG. 2.

FIG. 6 is a conceptual view for describing an action of the polarization diffraction element shown in FIG. 2.

FIG. 7 is a view conceptually showing an exposure device which forms a liquid crystal alignment pattern.

FIG. 8 is a conceptual view showing the action of the optical device according to the embodiment of the present invention.

FIG. 9 is a plan view conceptually showing another example of the liquid crystal lens.

FIG. 10 is a plan view conceptually showing still another example of the liquid crystal lens.

FIG. 11 is a view conceptually showing an example of an AR image display apparatus according to an embodiment of the present invention.

### DESCRIPTION OF THE PREFERRED EMBODIMENTS

Hereinafter, the optical device and the head mounted display (HMD) according to the present invention will be described in detail based on suitable embodiments shown in the accompanying drawings.

Drawings shown below are conceptual diagrams for explaining the present invention, and the shape, thickness, size, positional relationship, and the like of each member do not necessarily match those of the actual device.

In addition, examples described below show representative embodiments of the present invention. However, the present invention is not limited to the embodiments shown below.

Any numerical range expressed using “to” in the present specification refers to a range including the numerical values before and after the “to” as a lower limit value and an upper limit value, respectively.

In addition, although not limited thereto, light in a wavelength range of 420 to 490 nm is blue light (B light), light in a wavelength range of 495 to 570 nm is green light (G light), and light in a wavelength range of 580 to 700 nm is red light (R light).

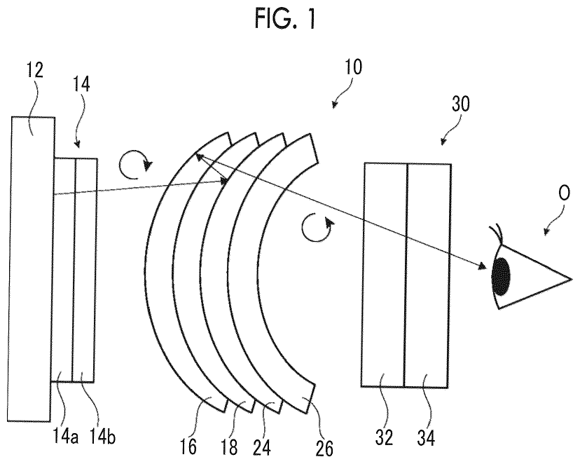

FIG. 1 conceptually shows an example of a VR image display apparatus which is the head mounted display (HMD) according to the embodiment of the present invention and uses an example of the optical unit according to the embodiment of the present invention.

A VR image display apparatus 10 shown in FIG. 1 is an image display apparatus which displays (projects) a virtual reality image (VR image) for the user O to observe. In the following description, the VR image display apparatus 10 will be simply referred to as “display apparatus 10”.

As shown in FIG. 1, the display apparatus 10 includes a display 12, a circular polarization plate 14, a half mirror 16, a lens 18, a circularly polarized light reflective polarizer 24, a circular polarization plate 26, and an optical device 30.

The half mirror 16, the lens 18, the circularly polarized light reflective polarizer 24, and the circular polarization plate 26 form a light-converging optical system in the display apparatus 10.

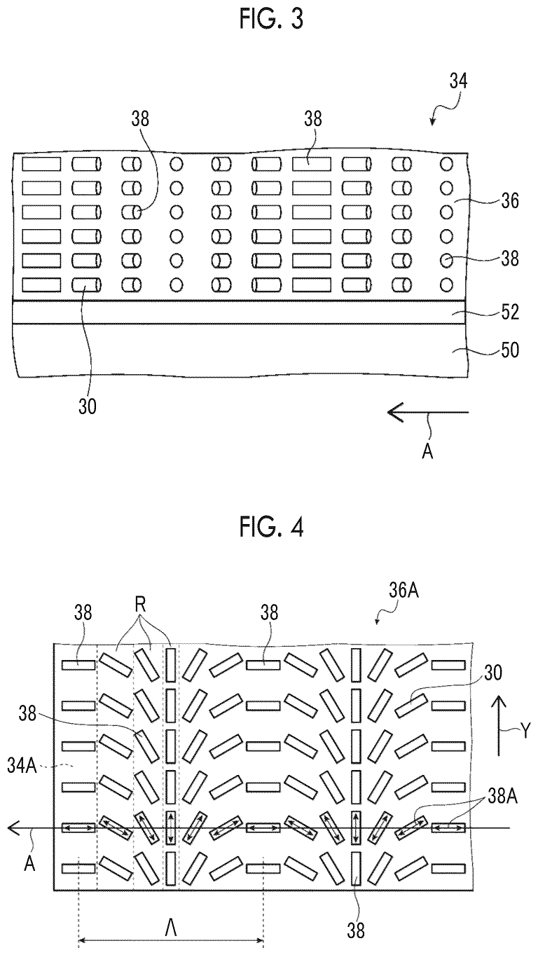

In addition, the optical device 30 is the optical device according to the embodiment of the present invention. In the example shown in the drawing, the optical device 30 includes a switching element 32 and a liquid crystal lens 34. In addition, the liquid crystal lens 34 has a liquid crystal layer 36 (see FIG. 3).

The display apparatus 10 shown in FIG. 1 is basically the same as a VR image display apparatus including a known folded optical system such as a pancake lens, except that the display apparatus 10 includes the optical device 30 which is the optical device according to the embodiment of the present invention.

In the display apparatus 10, an image (light) displayed on the display 12 is, for example, dextrorotatory circularly polarized by the circular polarization plate 14, and about half of the image is transmitted through the half mirror 16 and the lens 18 and is incident on the circularly polarized light reflective polarizer 24.

The circularly polarized light reflective polarizer 24 is, for example, a reflective polarizer which selectively reflects dextrorotatory circularly polarized light and transmits levorotatory circularly polarized light. Therefore, the image which is dextrorotatory circularly polarized light is reflected by the circularly polarized light reflective polarizer 24, is incident on the half mirror 16 again, and is reflected by the half mirror 16 by about half.

The image of the dextrorotatory circularly polarized light reflected by the half mirror 16 is converted into levorotatory circularly polarized light.

The image of levorotatory circularly polarized light, reflected by the half mirror 16, is collected by the lens 18 and is incident on the circularly polarized light reflective polarizer 24 again. As described above, the circularly polarized light reflective polarizer 24 is a reflective polarizer which selectively reflects dextrorotatory circularly polarized light and allows transmission of levorotatory circularly polarized light. Therefore, the image of levorotatory circularly polarized light, incident on the circularly polarized light reflective polarizer 24 again, is transmitted through the circularly polarized light reflective polarizer 24.

The image of levorotatory circularly polarized light, transmitted through the circularly polarized light reflective polarizer 24, is incident on the circular polarization plate 26. The circular polarization plate 26 blocks the dextrorotatory circularly polarized light in order to prevent the dextrorotatory circularly polarized light which is unnecessarily transmitted from being stray light (ghost) in a case where the image of dextrorotatory circularly polarized light is incident on the circularly polarized light reflective polarizer 24 first. That is, the circular polarization plate is a circular polarization plate which transmits levorotatory circularly polarized light and blocks, preferably absorbs dextrorotatory circularly polarized light. Therefore, the image of levorotatory circularly polarized light, incident on the circular polarization plate 26, is transmitted through the circular polarization plate 26.

The image of levorotatory circularly polarized light, transmitted through the circular polarization plate 26, is collected, is incident on the optical device 30, is transmitted through the optical device 30, and is adjusted to have a focal length and is observed as a virtual reality image by the user O.

The optical device 30 will be described in detail later.

The VR image display apparatus according to the present invention is basically a known VR image display apparatus, except that the VR image display apparatus includes the optical device 30 which is the optical device according to the embodiment of the present invention.

Therefore, the VR image display apparatus according to the embodiment of the present invention is not limited to the configuration shown in FIG. 1, and various known VR image display apparatuses can be used.

In the display apparatus 10, various known displays (image display devices) can be used as the display 12.

Examples of the display 12 include a liquid crystal display device (LCD), an organic electroluminescent display device (organic light emitting diode; OLED), a cathode-ray tube (CRT), a plasma display device, a light emitting diode (LED) display device, a micro LED display device, a laser display, a digital light processing (DLP)-type display device, and a micro-electro-mechanical system (MEMS)-type display device. In the present invention, the liquid crystal display device includes liquid crystal on silicon (LCOS).

In the display apparatus 10, the circular polarization plate 14 is not limited, and various known circular polarization plates (circular polarizers) which convert the image (light) emitted from the display 12 into circularly polarized light in a predetermined turning direction can be used.

The circular polarization plate 14 of the example shown in the drawing is a circular polarization plate consisting of a linear polarizer 14a and a quarter waveplate (λ/4 plate) 14b. That is, the circular polarization plate 14 converts the image emitted from the display 12 into linearly polarized light in a predetermined direction by the linear polarizer 14a, and then converts the linearly polarized light into circularly polarized light in a predetermined turning direction by the quarter waveplate 14b.

As described above, in the display apparatus 10 of the example shown in the drawing, the circular polarization plate 14 converts the image emitted from the display 12 into dextrorotatory circularly polarized light.

However, the present invention is not limited thereto, and the circular polarization plate 14 may convert the image emitted from the display 12 into levorotatory circularly polarized light. In this case, the circularly polarized light reflective polarizer 24 described later selectively reflects levorotatory circularly polarized light and transmits dextrorotatory circularly polarized light.

That is, in the display apparatus according to the embodiment of the present invention, the turning direction of the circularly polarized light of the image incident on the optical device 30 according to the embodiment of the present invention is not limited. Therefore, in the display apparatus according to the embodiment of the present invention, the turning direction of the circularly polarized light transmitted through the polarizer may be selected, and the set circularly polarized light may be incident on the optical device by using a half waveplate or the like as necessary.

In the display apparatus 10, the linear polarizer 14a and the quarter waveplate 14b are not limited, and various known members can be used.

Therefore, the linear polarizer 14a may be a reflective polarizer or an absorptive polarizer; and various known linear polarizers such as an iodine-based polarizer, a dye-based polarizer using a dichroic dye, a polyene-based polarizer, a wire grid polarizer, and a film obtained by stretching a dielectric multi-layer film described in JP2011-053705A can be used.

In addition, as the quarter waveplate 14b, various known quarter waveplates such as a stretched polycarbonate film, a stretched norbornene-based polymer film, a transparent film in which inorganic particles having birefringence, such as strontium carbonate, are contained and aligned, a thin film with an inorganic dielectric obliquely deposited on a substrate, a film in which a polymerizable liquid crystal compound is uniaxially aligned and the alignment is fixed, and a film in which a liquid crystal compound is uniaxially aligned and the alignment is fixed can be used.

Regarding this point, the same applies to other linear polarizers and quarter waveplates.

In a case where the display 12 emits linearly polarized light, such as a liquid crystal display device and an organic electroluminescent display device having an anti-reflection film, the quarter waveplate 14b may be disposed without using the linear polarizer 14a.

In the display apparatus 10 according to the embodiment of the present invention, the half mirror 16 is not limited, and various known half mirrors can be used.

In addition, in the display apparatus 10, the lens 18 is not limited, and various known lenses (convex lenses) which converge incident light can be used. In the example shown in the drawing, the lens 18 is, for example, a plano-convex lens.

In the display apparatus 10 according to the embodiment of the present invention, the circularly polarized light reflective polarizer 24 is not limited, and various known reflective circular polarization plates which selectively reflect dextrorotatory circularly polarized light or levorotatory circularly polarized light and allow transmission of circularly polarized light of which a turning direction is opposite to that of the reflected light can be used.

Preferred examples of the circularly polarized light reflective polarizer 24 include a cholesteric liquid crystal layer.

The cholesteric liquid crystal layer is a liquid crystal layer obtained by fixing a liquid crystal phase (cholesteric liquid crystalline phase) consisting of cholesterically aligned liquid crystal compounds.

As is well known, the cholesteric liquid crystal layer has a helical structure in which the liquid crystal compounds are helically turned and stacked. In the helical structure, a configuration in which the liquid crystal compound is helically rotated once (rotated by 360°) and laminated is set as one pitch (helical pitch), and the helically turned liquid crystal compounds are laminated a plurality of pitches.

In addition, as is well known, the cholesteric liquid crystal layer selectively reflects levorotatory circularly polarized light or dextrorotatory circularly polarized light in a specific wavelength range and allows the transmission of the other light depending on a helical turning direction (sense) of the liquid crystal compound.

Specifically, the cholesteric liquid crystal layer selectively reflects light in a specific wavelength range and allows the transmission of light in other wavelength ranges according to the length of one helical pitch. A central wavelength λ of selective reflection (selective reflection central wavelength λ) of the cholesteric liquid crystal layer depends on a single helical pitch P of the helical structure in the cholesteric liquid crystalline phase, and follows a relationship λ=n× P with an average refractive index n of the cholesteric liquid crystal structure. The single helical pitch P of the helical structure is a period of the helix, and is a length in a thickness direction in which the liquid crystal compound rotates by 360°.

In addition, depending on the helical turning direction (sense), the cholesteric liquid crystal layer reflects dextrorotatory circularly polarized light and allows transmission of levorotatory circularly polarized light, or reflects levorotatory circularly polarized light and allows transmission of dextrorotatory circularly polarized light. The turning direction of the circularly polarized light reflected by the cholesteric liquid crystal layer matches a helical sense of the cholesteric liquid crystalline phase.

As the cholesteric liquid crystal layer, various known cholesteric liquid crystal layers obtained by fixing the cholesteric liquid crystalline phase can be used.

In addition, the cholesteric liquid crystal layer may be a cholesteric liquid crystal layer having a so-called pitch gradient structure (PG structure) in which the helical pitch changes in the thickness direction.

As described above, the cholesteric liquid crystal layer selectively reflects light in a specific wavelength range and allows the transmission of light in other wavelength ranges.

Accordingly, in a case where the circularly polarized light reflective polarizer 24 is composed of the cholesteric liquid crystal layer, the circularly polarized light reflective polarizer 24 may have only one cholesteric liquid crystal layer or may have a plurality of cholesteric liquid crystal layers depending on the display image of the display 12.

For example, in a case where the display 12 displays a full color image or a black-and-white image, the circularly polarized light reflective polarizer 24 may have three cholesteric liquid crystal layers including a cholesteric liquid crystal layer having a selective reflection central wavelength in a wavelength range of the blue light, a cholesteric liquid crystal layer having a selective reflection central wavelength in a wavelength range of the green light, and a cholesteric liquid crystal layer having a selective reflection central wavelength in a wavelength range of the red light.

In the display apparatus 10, various known circular polarization plates 26 which block circularly polarized light in a predetermined turning direction and transmit the other circularly polarized light can be used as the circular polarization plate 26.

As described above, the circular polarization plate 26 blocks the dextrorotatory circularly polarized light which is unnecessarily transmitted in a case where the image of the dextrorotatory circularly polarized light is incident on the circularly polarized light reflective polarizer 24 first.

Examples of the circular polarization plate 26 include a circular polarization plate which includes a quarter waveplate, a linear polarizer, and a quarter waveplate in this order. In the circular polarization plate 26, the dextrorotatory circularly polarized light which is unnecessarily transmitted through the circularly polarized light reflective polarizer 24 is converted into linearly polarized light in a direction in which the linear polarizer blocks light by the quarter waveplate on the upstream side, and the dextrorotatory circularly polarized light which is unnecessarily transmitted through the circularly polarized light reflective polarizer 24 is blocked. In consideration of this point, the linear polarizer is preferably an absorptive linear polarizer.

On the other hand, in a case where appropriate levorotatory circularly polarized light transmitted through the circularly polarized light reflective polarizer 24 is incident on the circular polarization plate 26, the levorotatory circularly polarized light is converted into linearly polarized light having a polarization direction which is opposite to that for the dextrorotatory circularly polarized light and can be transmitted through the linear polarizer. The linearly polarized light converted from the levorotatory circularly polarized light is converted into levorotatory circularly polarized light again by the quarter waveplate on the downstream side.

The image of levorotatory circularly polarized light, transmitted through the circular polarization plate 26, is incident on the optical device 30.

As described above, the optical device 30 is the optical device according to the embodiment of the present invention, which includes the switching element 32 and the liquid crystal lens 34.

The optical device 30 extends or shortens the focal length of the display apparatus 10 by switching of the switching element 32. That is, by including the optical device 30, the display apparatus 10 can change the focal length of the image (projection image) observed by the user O.

The switching element 32 is an element which is configured to switch between a first phase difference and a second phase difference. In addition, a difference between the first phase difference and the second phase difference switched by the switching element 32 is 275±20 nm at a wavelength of 550 nm.

As an example, the switching element 32 is an element which is configured to switch between a state in which a phase difference is zero and a state in which a phase difference is a half wavelength (λ/2). That is, the switching element 32 is an element which is configured to switch between a state in which incident light passes through as it is and a state in which it acts as a half waveplate with respect to the incident light. Hereinafter, for convenience, the state in which the phase difference is zero is also referred to as “off”, and the state in which the phase difference is a half wavelength so as to act as a half waveplate is also referred to as “on”.

As described above, in the display apparatus 10, the image incident on the optical device 30 is the image of levorotatory circularly polarized light. Therefore, the switching element 32 is an element which can switch between a state in which the incident levorotatory circularly polarized light is transmitted as it is and a state in which the levorotatory circularly polarized light is converted into dextrorotatory circularly polarized light and is transmitted.

The switching element 32 is not limited, and various elements which can switch between the first phase difference and the second phase difference, in which the difference in phase difference at a wavelength of 550 nm is 275±20 nm, can be used.

Examples thereof include a switching element configured by using a liquid crystal cell. It is preferable that the liquid crystal cell is in a vertical alignment (VA) mode.

As shown in FIG. 1, the optical device 30 includes the liquid crystal lens 34 downstream of the switching element 32.

Therefore, the levorotatory circularly polarized light which passes through the switching element 32 as it is or the dextrorotatory circularly polarized light which is converted by the switching element 32 is incident on the liquid crystal lens 34.

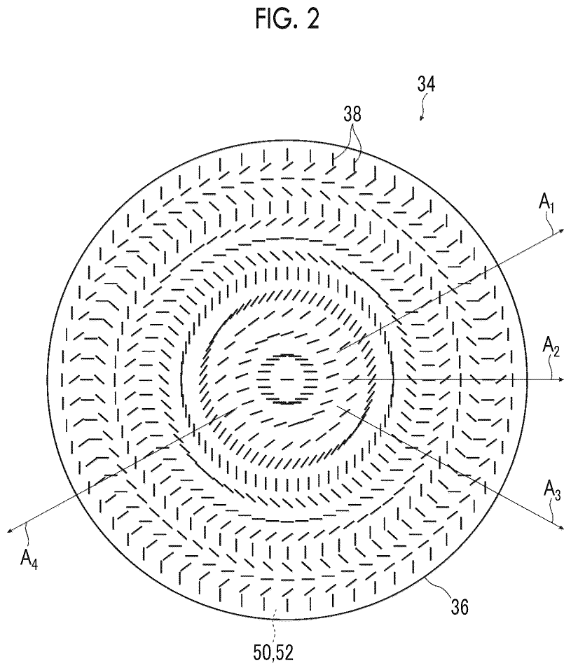

FIGS. 2 and 3 conceptually show an example of the liquid crystal lens 34. FIG. 2 is a plan view of the liquid crystal lens 34, and FIG. 3 is a cross-sectional view in a thickness direction.

As shown in FIGS. 2 and 3, the liquid crystal lens 34 has the liquid crystal layer 36 formed of a liquid crystal composition containing a liquid crystal compound 38. Here, in the present invention, a liquid crystal compound having reverse wavelength dispersibility is used as the liquid crystal compound 38. This will be described in detail later.

The liquid crystal layer 36 has a liquid crystal alignment pattern in which an orientation of an optical axis derived from the liquid crystal compound 38 changes while continuously rotating in at least one in-plane direction. In addition, as a preferred aspect of the liquid crystal layer 36, in the liquid crystal alignment pattern, in a case where a length over which an orientation of an optical axis derived from the liquid crystal compound 38 rotates by 180° in a plane is set as a single period, a region where a length of the single period varies is provided in the plane.

As shown in FIGS. 2 and 3, the liquid crystal lens 34 includes a substrate 50, an alignment film 52, and a liquid crystal layer 36 (optically anisotropic layer). In the liquid crystal lens 34, the liquid crystal layer 36 acts as a liquid crystal lens, that is, a liquid crystal diffraction element.

Accordingly, the liquid crystal lens 34 may be composed only of the liquid crystal layer 36, may be formed by peeling off the substrate 50 and then including the alignment film 52 and the liquid crystal layer 36, or may be formed by peeling off the substrate 50 and the alignment film 52 from the liquid crystal layer 36 and laminating the liquid crystal layer 36 on another substrate.

In the liquid crystal lens 34 shown in FIGS. 2 and 3, the liquid crystal layer 36 is a liquid crystal layer which is formed on the alignment film 52 using a composition containing a liquid crystal compound 38, in which the liquid crystal compound 38 is aligned and immobilized in the following liquid crystal alignment pattern.

Specifically, the liquid crystal layer 36 has a liquid crystal alignment pattern in which an orientation of an optical axis derived from the liquid crystal compound 38 changes while continuously rotating in one direction in a radial shape from an inner side toward an outer side. That is, the liquid crystal alignment pattern in the liquid crystal layer 36 shown in FIGS. 2 and 3 is a pattern having a plurality of rings, and is a concentric pattern including the one direction in which the orientation of the optical axis derived from the liquid crystal compound 38 changes while continuously rotating in a concentric circular shape from the inner side toward the outer side.

In FIG. 2 and FIG. 4 described later, in order to simplify the drawing and clarify the configuration of the liquid crystal layer 36, only the liquid crystal compound 38 at the interface of the liquid crystal layer 36 on the alignment film 52 side is shown. However, as shown in FIG. 3, the liquid crystal layer 36 has a configuration in which the liquid crystal compounds 38 are laminated in the thickness direction, similarly to a typical liquid crystal layer formed of a composition containing a liquid crystal compound.

Furthermore, in FIGS. 2 and 3, for example, a rod-like liquid crystal compound is exemplified as the liquid crystal compound 38, so that the direction of the optical axis matches with a longitudinal direction of the liquid crystal compound 38.

Specifically, in the liquid crystal layer 36, the orientation of the optical axis of the liquid crystal compound 38 changes while continuously rotating along a plurality of directions from the center, that is, the optical axis of the liquid crystal layer 36 toward the outer side, for example, along a direction indicated by an arrow A₁, a direction indicated by an arrow A₂, a direction indicated by an arrow A₃, a direction indicated by an arrow A₄, and the like.

Accordingly, in the liquid crystal layer 36, the rotation direction of the optical axes of the liquid crystal compounds 38 is the same in all directions (one direction). In the example shown in the drawing, the rotation direction of the optical axes of the liquid crystal compounds 38 is counterclockwise, in all the directions including the direction indicated by the arrow A₁, the direction indicated by the arrow A₂, the direction indicated by the arrow A₃, and the direction indicated by the arrow A₄.

That is, in a case where the arrow A₁ and the arrow A₄ are regarded as one straight line, the rotation direction of the optical axes of the liquid crystal compounds 38 is reversed at the center of the liquid crystal layer 36 on the straight line. For example, the straight line formed by the arrow A₁ and the arrow A₄ is directed in the right direction (arrow A₁ direction) in the drawing. In this case, the optical axis of the liquid crystal compound 38 initially rotates clockwise from the outer side toward the center of the liquid crystal layer 36, the rotation direction is reversed at the center of the liquid crystal layer 36, and then the optical axis of the liquid crystal compound 38 rotates counterclockwise from the center to the outer side of the liquid crystal layer 36. The center of the liquid crystal layer 36 is the optical axis of the liquid crystal lens 34.

As is well known, the liquid crystal layer having the liquid crystal alignment pattern in which the orientation of the optical axis derived from the liquid crystal compound 38 changes while continuously rotating in the one direction acts as a transmissive liquid crystal diffraction element which diffracts incident circularly polarized light in the one direction and the reverse direction according to the rotation direction of the optical axis and the turning direction of the incident circularly polarized light.

In the liquid crystal layer 36 having the liquid crystal alignment pattern in which the orientation of the optical axis of the liquid crystal compound 38 changes while continuously rotating in the one direction, a diffraction direction (refraction direction) of transmitted light depends on the rotation direction of the optical axes of the liquid crystal compounds 38. That is, in the liquid crystal alignment pattern, in a case where the rotation directions of the optical axes of the liquid crystal compounds 38 in the one direction are opposite to each other, the diffraction direction of transmitted light is opposite to the one direction in which the optical axis rotates.

In addition, in the liquid crystal layer 36 having the liquid crystal alignment pattern in which the orientation of the optical axis of the liquid crystal compound 38 changes while continuously rotating in the one direction, the diffraction direction of transmitted light varies depending on the turning direction of the incident circularly polarized light. That is, in the liquid crystal alignment pattern, the diffraction direction of transmitted light is reversed between a case where the incident light is dextrorotatory circularly polarized light and a case where the incident light is levorotatory circularly polarized light.

Furthermore, in a case where an in-plane retardation (retardation in the plane direction) value is set to 2/2, the liquid crystal layer 36 has a function as a typical half waveplate, that is, has a function of imparting a phase difference of a half wavelength, that is, 180° to a polarized light component incident into the liquid crystal layer.

Accordingly, the circularly polarized light which is incident into and diffracted by the liquid crystal layer 36 has an opposite turning direction. That is, the dextrorotatory circularly polarized light incident into and diffracted by the liquid crystal layer 36 is emitted as levorotatory circularly polarized light; and the levorotatory circularly polarized light is emitted as dextrorotatory circularly polarized light.

In the liquid crystal layer 36 of the liquid crystal lens 34, in the liquid crystal alignment pattern, in a case where the length over which the orientation of the optical axis derived from the liquid crystal compound rotates by 180° in one direction in which the orientation of the optical axis derived from the liquid crystal compound 38 changes while continuously rotating is set as a single period, the length of the single period gradually decreases from the inner side toward the outer side. That is, the liquid crystal layer 36 of the example shown in the drawing has, in the plane, a region where a length of the single period varies.

Here, in the liquid crystal layer having the liquid crystal alignment pattern in which the orientation of the optical axis of the liquid crystal compound 38 changes while continuously rotating in the one direction, the diffraction angle increases as the length of the single period decreases. Accordingly, in the liquid crystal layer 36 having the concentric circular liquid crystal alignment pattern, the diffraction angle gradually increases from the center of the concentric circle toward the outer direction.

Accordingly, the liquid crystal layer 36 having the concentric circular liquid crystal alignment pattern with the liquid crystal alignment pattern in which the optical axis derived from the liquid crystal compound changes while continuously rotating in a radial shape can transmit an incidence ray by diverging or focusing the ray depending on the rotation direction of the optical axis of the liquid crystal compound 38 and the turning direction of the incident circularly polarized light.

In other words, the liquid crystal lens 34 having the liquid crystal layer 36 acts as a concave lens in a case where dextrorotatory circularly polarized light is incident and acts as a convex lens in a case where levorotatory circularly polarized light, depending on the turning direction of the incident circularly polarized light. Alternatively, the liquid crystal lens 34 acts as a convex lens in a case where dextrorotatory circularly polarized light is incident, and acts as a concave lens in a case where levorotatory circularly polarized light is incident.

In the example shown in the drawing, as an example, the liquid crystal layer 36 acts as a convex lens to converge light in a case where levorotatory circularly polarized light is incident and acts as a concave lens to diverge light in a case where dextrorotatory circularly polarized light is incident.

In order to realize natural stereoscopic viewing in the HMD, it is preferable that the observation image can be adjusted from infinity to the vicinity of the user's hand. As an example, it is preferable that a distance from the user of the HMD to the observation image can be adjusted from infinity to 25 cm.

As described above, the optical device 30 extends or shortens the focal length of the display apparatus 10 by switching of the switching element 32.

A control range of a focal power of the optical device 30, which can be controlled by switching of the switching element 32, is preferably 1 to 5 diopters. As an example, in a case where the control range of the focal power is 4 diopters, in one aspect, the focal power of the optical device 30 is in a range of 0 to 4 diopters, and in another aspect, the focal power of the optical device 30 is in a range of −2 to 2 diopters.

Here, the diopter is a unit of the focal power of the lens, and is the reciprocal of the focal length in meters.

In a case where the control range of the focal power of the optical device 30 is 1 diopter or more, the user can feel an effect of approaching natural stereoscopic viewing. In addition, by setting the control range of the focal power of the optical device 30 to 4 diopters, the distance from the user of the HMD to the observation image can be adjusted from infinity to 25 cm.

In order for the optical device 30 to achieve the above-described control range of the focal power, an absolute value of the focal power of the liquid crystal lens 34 is preferably 0.01 to 2.5 diopters.

As described above, the liquid crystal lens 34 acts as a concave lens in a case where dextrorotatory circularly polarized light is incident and acts as a convex lens in a case where levorotatory circularly polarized light, depending on the turning direction of the incident circularly polarized light. For example, the liquid crystal lens 34 having a focal power of 2.0 diopters with respect to the levorotatory circularly polarized light has a focal power of −2.0 diopters with respect to the dextrorotatory circularly polarized light. In this case, the control range of the focal power of the optical device 30 by switching of the switching element 32 is 4 diopters.

The absolute value of the focal power of the liquid crystal lens 34 is more preferably 0.01 to 1.5 diopters and still more preferably 0.5 to 1.0 diopters. By setting the absolute value of the focal power of the liquid crystal lens 34 within the range, it is possible to prevent the image quality from fluctuating depending on the distance from the user of the HMD to the observation image.

The optical device 30 may have a multi-stage configuration in which a plurality of switching elements and a plurality of liquid crystal lenses are alternately arranged. In this manner, the focal power of the optical device 30 can be controlled in stages. In a case where one set of the switching element and the liquid crystal lens is used, two types of focal powers can be achieved, whereas in a case where two sets of the switching element and the liquid crystal lens are used, four types of focal powers can be achieved. In addition, in a case where four sets of the switching element and the liquid crystal lens are used, 16 types of focal powers can be achieved.

By finely controlling the focal power, a natural stereoscopic experience can be provided to the user.

The liquid crystal lens 34 (liquid crystal layer 36) preferably has an alignment structure in which the above-described focal power is exhibited. The single period in the liquid crystal layer 36 varies depending on a distance from the optical center. As an example, the minimum value of the single period of a lens having a diameter of 5 cm and a focal power of 1 diopter is approximately 20 μm.

In order to simplify the drawing to clarify the configuration of the liquid crystal lens 34 in FIG. 2, only the liquid crystal compound 38 (liquid crystal compound molecule) on the surface of the alignment film 52 in the liquid crystal layer 36 is also shown. However, as conceptually shown in FIG. 3, the liquid crystal layer 36 has a structure in which the aligned liquid crystal compounds 38 are stacked in the thickness direction, similarly to a liquid crystal layer formed of a composition containing a typical liquid crystal compound.

Hereinafter, the action of the liquid crystal layer 36 will be described in more detail with reference to a liquid crystal layer 36A having a liquid crystal alignment pattern in which an optical axis 38A derived from the liquid crystal compound 38 changes while continuously rotating in the one direction indicated by an arrow A, conceptually shown in a plan view of FIG. 4.

Even in the concentric circular liquid crystal alignment pattern shown in FIG. 2 in which the optical axis changes while continuously rotating in one direction in a radial shape from the inner side toward the outer side, the same optical effects as those of the liquid crystal alignment pattern shown in FIG. 4 can be exhibited for the one direction in which the optical axis changes while continuously rotating.

In the following description, the optical axis 38A derived from the liquid crystal compound 38 will also be referred to as “optical axis 38A of the liquid crystal compound 38” or “optical axis 38A”.

In the liquid crystal layer 36A, the liquid crystal compound 38 is two-dimensionally aligned in a plane parallel to the one direction indicated by the arrow A and a Y direction orthogonal to the arrow A direction. In FIG. 3 and FIGS. 5 and 6 described below, the Y direction is a direction orthogonal to the paper plane.

In the following description, “one direction indicated by the arrow A” will also be simply referred to as “arrow A direction”.

In the liquid crystal layer 36 shown in FIG. 2, a circumferential direction of the concentric circle in the concentric circular liquid crystal alignment pattern corresponds to the Y direction in FIG. 4.

The liquid crystal layer 36A has a liquid crystal alignment pattern in which the orientation of the optical axis 38A derived from the liquid crystal compound 38 changes while continuously rotating in the arrow A direction in a plane of the liquid crystal layer 36A.

Specifically, the “orientation of the optical axis 38A of the liquid crystal compound 38 changes while continuously rotating in the arrow A direction (predetermined one direction)” means that an angle between the optical axis 38A of the liquid crystal compound 38, which is arranged in the arrow A direction, and the arrow A direction varies depending on positions in the arrow A direction, and the angle between the optical axis 38A and the arrow A direction sequentially changes from θ to θ+180° or to θ-180° in the arrow A direction.

Meanwhile, regarding the liquid crystal compound 38 forming the liquid crystal layer 36A, the liquid crystal compounds 38 in which the orientations of the optical axes 38A are the same as one another are arranged at equal intervals in the Y direction orthogonal to the arrow A direction, that is, the Y direction orthogonal to one direction in which the optical axes 38A continuously rotate.

In other words, regarding the liquid crystal compound 38 forming the liquid crystal layer 36, in the liquid crystal compounds 38 arranged in the Y direction, angles between the orientations of the optical axes 38A and the arrow A direction are the same.

In the liquid crystal layer 36 shown in FIG. 2, a region where the orientations of the optical axes 38A are the same is formed in an annular shape where the centers match with each other, and a concentric circular liquid crystal alignment pattern is formed.

As described above, in the liquid crystal alignment pattern in which the optical axis 38A continuously rotates in the one direction, the length (distance) over which the optical axis 38A of the liquid crystal compound 38 rotates by 180° is a length A of the single period in the liquid crystal alignment pattern.

That is, in the liquid crystal layer 36A shown in FIG. 4, the length (distance) over which the optical axis 38A of the liquid crystal compound 38 rotates by 180° in the arrow A direction in which the orientation of the optical axis 38A changes while continuously rotating in a plane is set as the single period Λ in the liquid crystal alignment pattern. In other words, the single period Λ in the liquid crystal alignment pattern is defined as a distance from θ to θ+180° of the angle between the optical axis 38A of the liquid crystal compound 38 and the arrow A direction.

In other words, a distance between centers of two liquid crystal compounds 38 in the arrow A direction is the single period A, the two liquid crystal compounds having the same angle in the arrow A direction. Specifically, as shown in FIG. 4, a distance between centers of two liquid crystal compounds 38 in the arrow A direction, in which the arrow A direction and the direction of the optical axis 38A match with each other, is the single period A.

In the liquid crystal alignment pattern in the liquid crystal layer 36A (liquid crystal layer 36), the single period Λ is repeated in the arrow A direction, that is, in one direction in which the orientation of the optical axis 38A changes while continuously rotating.

As described above, the liquid crystal layer 36A having such a liquid crystal alignment pattern is also a transmissive liquid crystal diffraction element, and the single period A is the period (single period) of the diffraction structure.

In the liquid crystal layer 36A, the liquid crystal compounds arranged in the Y direction have the same angle between the optical axis 38A and the arrow A direction. A region where the liquid crystal compounds 38 having the same angles between the optical axes 38A and the arrow A direction are arranged in the Y direction will be referred to as a region R.

In this case, it is preferable that an in-plane retardation (Re) value of each of the regions R is a half wavelength, that is, 2/2. The in-plane retardation is calculated from a product of a difference Δn in refractive index due to refractive index anisotropy of the region R and a thickness of the liquid crystal layer. Here, the difference in refractive index due to the refractive index anisotropy of the regions R in the liquid crystal layer is defined by a difference between a refractive index of a direction of an in-plane slow axis of the region R and a refractive index of a direction orthogonal to the direction of the slow axis. That is, the difference Δn in refractive index due to the refractive index anisotropy of the regions R is the same as a difference between a refractive index of the liquid crystal compound 38 in the direction of the optical axis 38A and a refractive index of the liquid crystal compound 38 in a direction perpendicular to the optical axis 38A in a plane of the region R. That is, the above-described difference in refractive index Δn is the same as the difference in refractive index of the liquid crystal compound.

In the liquid crystal lens 34 having the concentric circular liquid crystal alignment pattern with the liquid crystal alignment pattern in which the optical axis 38A continuously rotates in one direction in a radial shape, regions where the orientations of the optical axes 38A are the same and that are formed in an annular shape where the centers match with each other correspond to the region R in FIG. 4.

In a case where circularly polarized light is incident into the liquid crystal layer 36A, the light is diffracted and a direction of the circularly polarized light is changed.

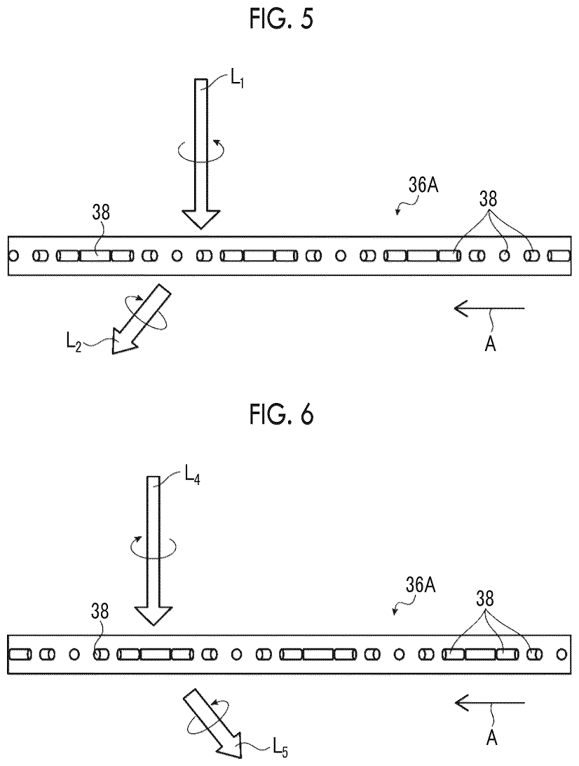

The action is conceptually shown in FIGS. 5 and 6. In the liquid crystal layer 36A, the value of the product of the difference in refractive index of the liquid crystal compound and the thickness of the liquid crystal layer is λ/2.

As described above, the action is also the same in the liquid crystal lens 34 having the concentric circular liquid crystal alignment pattern with the liquid crystal alignment pattern in which the optical axis 38A continuously rotates in the one direction in a radial shape.

As shown in FIG. 5, in a case where the value of the product of the difference in refractive index of the liquid crystal compound of the liquid crystal layer 36 and the thickness of the liquid crystal layer 36 is λ/2, and an incidence ray L₁ as levorotatory circularly polarized light is incident into the liquid crystal layer 36, the incidence ray L₁ transmits the liquid crystal layer 36A to be imparted with a retardation of 180°, and thus is converted into a transmitted ray L₂ as dextrorotatory circularly polarized light.

In addition, the liquid crystal alignment pattern formed in the liquid crystal layer 36 is a pattern which is periodic in the arrow A direction, so that the transmitted ray L₂ travels in a direction different from a traveling direction of the incidence ray L₁. In this way, the incidence ray L₁ of the levorotatory circularly polarized light is converted into the transmitted ray L₂ of the dextrorotatory circularly polarized light, which is tilted by a predetermined angle in a direction to the arrow A direction with respect to an incidence direction.

On the other hand, as conceptually shown in FIG. 6, in a case where the value of the product of the difference in refractive index of the liquid crystal compound of the liquid crystal layer 36A and the thickness of the liquid crystal layer 36A is 2/2, and an incidence ray L₄ as dextrorotatory circularly polarized light is incident into the liquid crystal layer 36A, the incidence ray L₄ transmits the liquid crystal layer 36 to be imparted with a retardation of 180°, and thus is converted into a transmitted ray L₅ as levorotatory circularly polarized light.

In addition, the liquid crystal alignment pattern formed in the liquid crystal layer 36A is a pattern which is periodic in the arrow A direction, so that the transmitted ray L₅ travels in a direction different from a traveling direction of the incidence ray L₄. In this case, the transmitted ray L₅ travels in a direction different from the transmitted ray L₂, that is, in a direction opposite to the arrow A direction with respect to the incidence direction. In this way, the incidence ray L₄ is converted into the transmitted ray L₅ of the levorotatory circularly polarized light, which is tilted by a predetermined angle in the arrow A direction with respect to the incidence direction.

In the liquid crystal layer 36A, it is preferable that the in-plane retardation value of the plurality of the regions R is a half wavelength, and it is preferable that an in-plane retardation Re(550)=Δn₅₅₀× d of the plurality of the regions R of the liquid crystal layer 36A with respect to an incidence ray having a wavelength of 550 nm is in a range defined by the following expression (1). Here, Δn₅₅₀ is a difference in refractive index due to the refractive index anisotropy of the region R in a case where the wavelength of the incidence light is 550 nm, and d represents a thickness of the liquid crystal layer 36A.

$$200 nm \leq Δ {n}_{550} \times d \leq 350 nm \qquad ( 1 )$$

That is, in a case where the “in-plane retardation Re(550)=Δn₅₅₀× d” of the plurality of the regions R of the liquid crystal layer 36A satisfies the expression (1), a sufficient amount of circularly polarized light components of light which has been incident into the liquid crystal layer 36A can be converted into circularly polarized light traveling in a direction tilted in a forward or backward direction with respect to the arrow A direction. It is more preferable that the in-plane retardation Re(550)=Δn₅₅₀× d is 225 nm≤Δn₅₅₀× d≤340 nm, and it is still more preferable that the in-plane retardation Re(550)=Δn₅₅₀× d is 250 nm≤Δn₅₅₀× d≤330 nm.

The above expression (1) is a range with respect to the incident light having a wavelength of 550 nm, but an in-plane retardation Re(λ)=Δn_{λ}× d of the plurality of the regions R of the liquid crystal layer with respect to incidence light having a wavelength of 2 nm is preferably in a range defined by the following expression (1-2), and can be appropriately set.

$$0.7 \times ( λ / 2 ) nm \leq Δ {n}_{λ} \times d \leq 1.3 \times ( λ / 2 ) nm \qquad ( 1 - 2 )$$

In addition, a value of the in-plane retardation of the plurality of the regions R of the liquid crystal layer 36A in a range outside the range of the above expression (1) can also be used. Specifically, by adopting Δn₅₅₀× d<200 nm or 350 nm<Δn₅₅₀×d, light can be classified into light which travels in the same direction as a traveling direction of the incidence ray and light which travels in a direction different from a traveling direction of the incidence ray. In a case where Δn₅₅₀× d approaches 0 nm or 550 nm, the light component traveling in the same direction as the traveling direction of the incidence ray increases, and the light component traveling in a direction different from the traveling direction of the incidence ray decreases.

As described above, by changing the single period Λ of the liquid crystal alignment pattern formed in the liquid crystal layer 36A, diffraction angles of the transmitted rays L₂ and L₅ can be adjusted. Specifically, as the single period Λ of the liquid crystal alignment pattern decreases, light transmitted through the liquid crystal compounds 38 adjacent to each other more strongly interfere with each other, so that the transmitted rays L₂ and L₅ can be more largely diffracted.

In addition, in the liquid crystal layer 36A, by reversing the rotation direction of the optical axes 38A of the liquid crystal compounds 38 which rotate in the arrow A direction, the diffraction direction of the transmitted light can be reversed.

Furthermore, as described above, in the liquid crystal layer 36A, the diffraction direction of the transmitted light is reversed depending on the turning direction of the incident circularly polarized light. That is, in the liquid crystal layer 36A, the diffraction directions of the transmitted light are opposite to each other between the dextrorotatory circularly polarized light and the levorotatory circularly polarized light.

Regarding the above points, the same applies to the liquid crystal layer 36 having the concentric circular liquid crystal alignment pattern as described above.

In a case of using the liquid crystal compound having reverse wavelength dispersibility described below, it is preferable that a value of a product of a difference in refractive index of the liquid crystal compound in the liquid crystal layer 36A and a thickness of the liquid crystal layer is larger than λ/2. Specifically, the thickness of the liquid crystal layer in the present invention particularly preferably satisfies Expression (1-3).

$$275 nm \leq Δ {n}_{550} \times d \leq 310 nm \qquad ( 1 - 3 )$$

A twisted angle of the liquid crystal layer is preferably 0° to 30°. The twisted angle of the liquid crystal layer is more preferably 3° to 20° and still more preferably 3° to 10°. In this manner, it is possible to obtain a high diffraction efficiency for light incident on the liquid crystal layer from an oblique angle.

The liquid crystal layer 36 is formed of a liquid crystal composition containing a liquid crystal compound, and has a liquid crystal alignment pattern in which an optical axis of the liquid crystal compound is aligned as described above.

By forming, on the substrate 50, the alignment film 52 having the alignment pattern corresponding to the above-described liquid crystal alignment pattern and applying the liquid crystal composition onto the alignment film 52, and curing the applied liquid crystal composition, the liquid crystal layer 36 including the cured layer of the liquid crystal composition can be formed.

The liquid crystal composition for forming the liquid crystal layer 36 contains the liquid crystal compound, and may further contain other components such as a leveling agent, an alignment control agent, a polymerization initiator, and an alignment assistant.

Here, in the present invention, the liquid crystal compound 38 constituting the liquid crystal layer 36 is a liquid crystal compound having reverse wavelength dispersibility. That is, the liquid crystal layer 36 is formed of a liquid crystal composition containing the liquid crystal compound 38 having reverse wavelength dispersibility.

The optical device according to the embodiment of the present invention includes the liquid crystal layer 36 using the liquid crystal compound having reverse wavelength dispersibility, so that it is possible to obtain an image having stable image quality regardless of the focal length in a case where the focal length of the display apparatus 10 is changed.

The liquid crystal compound having reverse wavelength dispersibility refers to a liquid crystal compound in which, in a case where an in-plane retardation (Re) value of a retardation film produced by aligning (horizontally aligning) the liquid crystal compound is measured at a specific wavelength (visible light range), the Re value increases as the measurement wavelength increases in a range of 450 to 650 nm.

A ratio Re450/Re550 of the retardation value Re450 at a wavelength of 450 nm to the retardation value Re550 at a wavelength of 550 nm is preferably 0.6 or more and less than 1.0. Re450/Re550 is more preferably 0.6 or more and less than 0.9, and still more preferably 0.7 or more and less than 0.8.

A ratio Re650/Re550 of the retardation value Re650 at a wavelength of 650 nm to the retardation value Re550 at a wavelength of 550 nm is preferably 1.0 or more and less than 1.3.

Δn₅₅₀ of the liquid crystal layer 36 is preferably 0.01 or more and less than 0.3, more preferably 0.01 or more and less than 0.15, still more preferably 0.03 or more and less than 0.1, and particularly preferably 0.03 or more and less than 0.06.

By controlling Δn₅₅₀ of the liquid crystal layer 36 within the range, it is possible to obtain preferable reverse wavelength dispersion optical characteristics.

As the liquid crystal compound having reverse wavelength dispersibility, a polymerizable liquid crystal compound having a partial structure represented by Formula (I) is preferable.

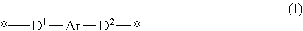

In Formula (I), D¹ and D² each independently represent a single bond, —O—, —CO—, —CO—O—, —C(═S)O—, —CR¹R²—, —CR¹R²—CR³R⁴—, —O—CR¹R²—, —CR¹R²—O—CR³R⁴—, —CO—O—CR¹R²—, —O—CO—CR¹R²—, —CR¹R²—CR³R⁴—O—CO—, —CR¹R²—O—CO—CR³R⁴—, —CR¹R²—CO—O—CR³R⁴—, —NR¹—CR²R³—, or —CO—NR¹—.

R¹, R², R³, and R⁴ each independently represent a hydrogen atom, a fluorine atom, or an alkyl group having 1 to 4 carbon atoms. In a case where there are a plurality of each of R¹'s, R²'s, R³'s, and R⁴'s, the plurality of R¹'s, the plurality of R²'s, the plurality of R³'s, and the plurality of R⁴'s each may be the same or different from each other.

Ar represents any aromatic ring selected from the group consisting of groups represented by Formulae (Ar-1) to (Ar-7). In Formulae (Ar-1) to (Ar-7), * represents a bonding position to D¹ or D², and descriptions of reference numerals in Formulae (Ar-1) to (Ar-7) are the same as those described by Ar in Formula (II), which will be described later.

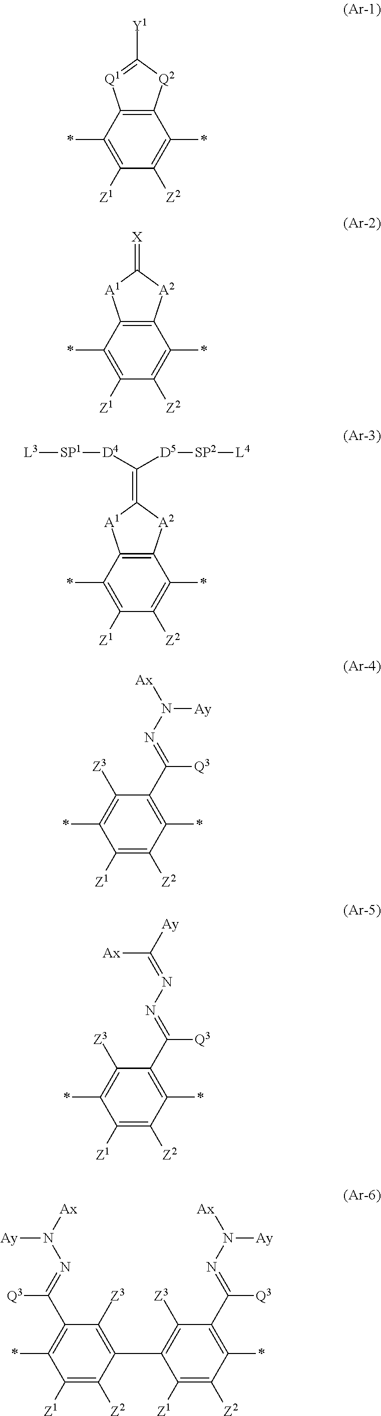

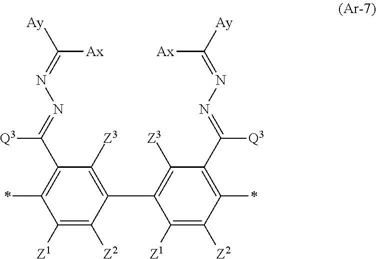

The polymerizable liquid crystal compound having a partial structure represented by Formula (I) is preferably a polymerizable liquid crystal compound represented by Formula (II).

The polymerizable liquid crystal compound represented by Formula (II) is a compound exhibiting liquid crystallinity.

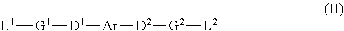

In Formula (II), D¹ and D² each independently represent a single bond, —O—, —CO—, —CO—O—, —C(═S)O—, —CR¹R²—, —CR¹R²—CR³R⁴—, —O—CR¹R²—, —CR¹R²—O—CR³R⁴—, —CO—O—CR¹R²—, —O—CO—CR¹R²—, —CR¹R²—CR³R⁴—O—CO—, —CR¹R²—O—CO—CR³R⁴—, —CR¹R²—CO—O—CR³R⁴—, —NR¹—CR²R³—, or —CO—NR¹—.

R¹, R², R³, and R⁴ each independently represent a hydrogen atom, a fluorine atom, or an alkyl group having 1 to 4 carbon atoms. In a case where there are a plurality of each of R¹'s, R²'s, R³'s, and R⁴'s, the plurality of R¹'s, the plurality of R²'s, the plurality of R³'s, and the plurality of R⁴'s each may be the same or different from each other.

G¹ and G² each independently represent a divalent alicyclic hydrocarbon group having 5 to 8 carbon atoms or an aromatic hydrocarbon group, and a methylene group included in the alicyclic hydrocarbon group may be substituted with —O—, —S—, or —NH—.

L₁ and L₂ each independently represent a monovalent organic group, and at least one selected from the group consisting of L₁ and L₂ represents a monovalent group having a polymerizable group.

Ar represents any aromatic ring selected from the group consisting of groups represented by Formulae (Ar-1) to (Ar-7). In Formulae (Ar-1) to (Ar-7), * represents a bonding position to D¹ or D².

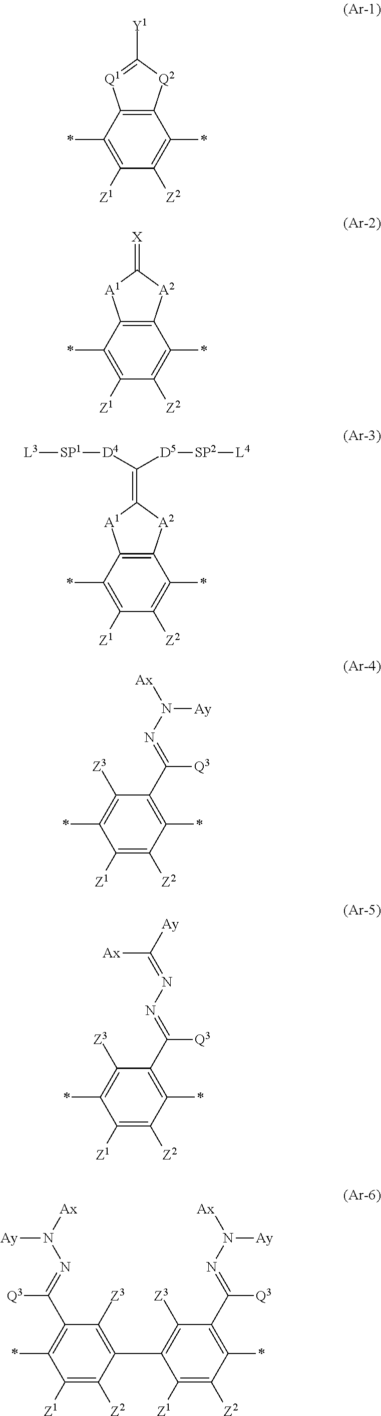

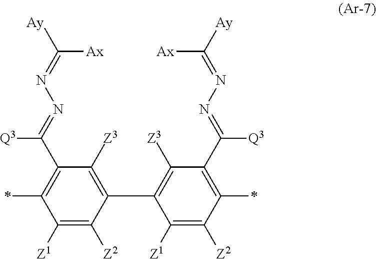

In Formula (Ar-1), Q¹ represents N or CH, Q² represents —S—, —O—, or —N(R⁷)—, R⁷ represents a hydrogen atom or an alkyl group having 1 to 6 carbon atoms, and Y¹ represents an aromatic hydrocarbon group having 6 to 12 carbon atoms or an aromatic heterocyclic group having 3 to 12 carbon atoms, each of which may have a substituent.

Examples of the alkyl group having 1 to 6 carbon atoms, represented by R⁷, include a methyl group, an ethyl group, a propyl group, an isopropyl group, an n-butyl group, an isobutyl group, a sec-butyl group, a tert-butyl group, an n-pentyl group, and a n-hexyl group.

Examples of the aromatic hydrocarbon group having 6 to 12 carbon atoms, represented by Y¹, include aryl groups such as a phenyl group, a 2,6-diethylphenyl group, and a naphthyl group.

Examples of the aromatic heterocyclic group having 3 to 12 carbon atoms, represented by Y¹, include heteroaryl groups such as a thienyl group, a thiazolyl group, a furyl group, and a pyridyl group.

In addition, examples of the substituent which may be included in Y¹ include an alkyl group, an alkoxy group, and a halogen atom.

As the alkyl group, an alkyl group having 1 to 18 carbon atoms is preferable, an alkyl group having 1 to 8 carbon atoms is more preferable, an alkyl group having 1 to 4 carbon atoms is still more preferable, and a methyl group or an ethyl group is particularly preferable. The alkyl group may be any of linear, branched, or cyclic.

As the alkoxy group, an alkoxy group having 1 to 18 carbon atoms is preferable, an alkoxy group having 1 to 8 carbon atoms is more preferable, an alkoxy group having 1 to 4 carbon atoms is still more preferable, and a methoxy group or an ethoxy group is particularly preferable.

Examples of the halogen atom include a fluorine atom, a chlorine atom, a bromine atom, and an iodine atom, and among these, a fluorine atom or a chlorine atom is preferable.

In addition, in Formulae (Ar-1) to (Ar-7), Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a halogen atom, a cyano group, a nitro group, —OR⁸, —NR⁹R¹⁰, or —SR¹¹, in which R⁸ to R¹¹ each independently represent a hydrogen atom or an alkyl group having 1 to 6 carbon atoms and Z¹ and Z² may be bonded to each other to form an aromatic ring.

As the monovalent aliphatic hydrocarbon group having 1 to 20 carbon atoms, an alkyl group having 1 to 15 carbon atoms is preferable; an alkyl group having 1 to 8 carbon atoms is more preferable; a methyl group, an ethyl group, an isopropyl group, a tert-pentyl group (1,1-dimethylpropyl group), a tert-butyl group, or a 1,1-dimethyl-3,3-dimethyl-butyl group is still more preferable; and a methyl group, an ethyl group, or a tert-butyl group is particularly preferable.

Examples of the monovalent alicyclic hydrocarbon group having 3 to 20 carbon atoms include: monocyclic saturated hydrocarbon groups such as a cyclopropyl group, a cyclobutyl group, a cyclopentyl group, a cyclohexyl group, a cycloheptyl group, a cyclooctyl group, a cyclodecyl group, a methylcyclohexyl group, and an ethylcyclohexyl group; monocyclic unsaturated hydrocarbon groups such as a cyclobutenyl group, a cyclopentenyl group, a cyclohexenyl group, a cycloheptenyl group, a cyclooctenyl group, a cyclodecenyl group, a cyclopentadienyl group, a cyclohexadienyl group, a cyclooctadienyl group, and a cyclodecadiene group; and polycyclic saturated hydrocarbon groups such as a bicyclo[2.2.1]heptyl group, a bicyclo[2.2.2]octyl group, a tricyclo[5.2.1.0^{2,6}]decyl group, a tricyclo[3.3.1.1^{3,7}]decyl group, a tetracyclo[6.2.1.1^{3,6}.0^{2,7}]dodecyl group, and an adamantyl group.

Examples of the monovalent aromatic hydrocarbon group having 6 to 20 carbon atoms include a phenyl group, a 2,6-diethylphenyl group, a naphthyl group, and a biphenyl group; and an aryl group having 6 to 12 carbon atoms (particularly, a phenyl group) is preferable.

Examples of the halogen atom include a fluorine atom, a chlorine atom, a bromine atom, and an iodine atom; and among these, a fluorine atom, a chlorine atom, or a bromine atom is preferable.

In addition, in Formulae (Ar-2) and (Ar-3), A¹ and A² each independently represent a group selected from the group consisting of —O—, —N(R¹²)—, —S—, and —CO—, and R¹² represents a hydrogen atom or a substituent.

Examples of the substituent represented by R¹² include the same substituent which may be included in Y¹ in Formula (Ar-1) described above.

In addition, in Formula (Ar-2), X represents a non-metal atom of Groups 14 to 16 to which a substituent may be bonded.

Examples of the non-metal atom of Groups 14 to 16, represented by X, include an oxygen atom, a sulfur atom, a nitrogen atom to which a hydrogen atom or a substituent is bonded [═N—R^{N1}, R^{N1} represents a hydrogen atom or a substituent], and a carbon atom to which a hydrogen atom or a substituent is bonded [═C—(R^{C1})₂, R^{C1} represents a hydrogen atom or a substituent]. As the substituent of R^{N1} or R^{C1}, CN is preferable.

In addition, in Formula (Ar-3), D⁴ and D⁵ each independently represent a single bond, —CO—, —O—, —S—, —C(═S)—, —CR¹ªR^{2a}—, —CR^{3a}—CR^{4a}—, —NR^{5a}—, or a divalent linking group consisting of a combination of two or more thereof, and R^{1a} to R^{5a} each independently represent a hydrogen atom, a fluorine atom, or an alkyl group having 1 to 4 carbon atoms.

Here, examples of the divalent linking group include —CO—, —O—, —CO—O—, —C(═S)O—, —CR^{1b}R^{2b}—, —CR^{1b}R^{2b}—CR^{1b}R^{2b}—, —O—CR^{1b}R^{2b}—, —CR^{1b}R^{2b}—O—CR^{1b}R^{2b}—, —CO—O—CR^{1b}R^{2b}—, —O—CO—CR^{1b}R^{2b}—, —CR^{1b}R^{2b}—O—CO—CR^{1b}R^{2b}—, —CR^{1b}R^{2b}—CO—O—CR^{1b}R^{2b}—, —NR^{3b}—CR^{1b}R^{2b}—, and —CO—NR^{3b}—. R^{1b}, R^{2b}, and R^{3b} each independently represent a hydrogen atom, a fluorine atom, or an alkyl group having 1 to 4 carbon atoms.

In addition, in Formula (Ar-3), SP¹ and SP² each independently represent a single bond, a linear or branched alkylene group having 1 to 12 carbon atoms, or a divalent linking group in which one or more —CH₂-'s constituting a linear or branched alkylene group having 1 to 12 carbon atoms are substituted with —O—, —S—, —NH—, —N(Q)-, or —CO—, in which Q represents a substituent. Examples of the substituent include the same substituent which may be included in Y¹ in Formula (Ar-1) described above.

In addition, in Formula (Ar-3), L₃ and L₄ each independently represent a monovalent organic group.

Examples of the monovalent organic group include an alkyl group, an aryl group, and a heteroaryl group. The alkyl group may be linear, branched, or cyclic, but is preferably linear. The number of carbon atoms in the alkyl group is preferably 1 to 30, more preferably 1 to 20, and still more preferably 1 to 10. In addition, the aryl group may be monocyclic or polycyclic, but is preferably monocyclic. The number of carbon atoms in the aryl group is preferably 6 to 25 and more preferably 6 to 10. In addition, the heteroaryl group may be monocyclic or polycyclic. The number of heteroatoms constituting the heteroaryl group is preferably 1 to 3. The heteroatom constituting the heteroaryl group is preferably a nitrogen atom, a sulfur atom, or an oxygen atom. The number of carbon atoms in the heteroaryl group is preferably 6 to 18 and more preferably 6 to 12. In addition, the alkyl group, the aryl group, and the heteroaryl group may be unsubstituted or have a substituent. Examples of the substituent include the same substituent which may be included in Y¹ in Formula (Ar-1) described above.

In addition, in Formulae (Ar-4) to (Ar-7), Ax represents an organic group having 2 to 30 carbon atoms, which has at least one aromatic ring selected from the group consisting of an aromatic hydrocarbon ring and an aromatic heterocyclic ring.

In addition, in Formulae (Ar-4) to (Ar-7), Ay represents a hydrogen atom, an alkyl group having 1 to 12 carbon atoms, which may have a substituent, or an organic group having 2 to 30 carbon atoms which has at least one aromatic ring selected from the group consisting of an aromatic hydrocarbon ring and an aromatic heterocyclic ring.

Here, the aromatic rings in Ax and Ay may have a substituent, and Ax and Ay may be bonded to each other to form a ring.

In addition, Q³ represents a hydrogen atom or an alkyl group having 1 to 6 carbon atoms, which may have a substituent.

Examples of Ax and Ay include those described in paragraphs to of WO2014/010325A.

In addition, specific examples of the alkyl group having 1 to 6 carbon atoms represented by Q³ include a methyl group, an ethyl group, a propyl group, an isopropyl group, a n-butyl group, an isobutyl group, a sec-butyl group, a tert-butyl group, a n-pentyl group, and a n-hexyl group; and examples of the substituent include the same substituents which may be included in Y¹ in Formula (Ar-1) described above.

With regard to the definition and preferred range of each substituent of the liquid crystal compound represented by Formula (II), the descriptions regarding D¹, D², G¹, G², L₁, L₂, R⁴, R⁵, R⁶, R⁷, X¹, Y¹, Q¹, and Q² for Compound (A) described in JP2012-021068A can be referred to for D¹, D², G¹, G², L₁, L₂, R¹, R², R³, R⁴, Q¹, Y¹, Z¹, and Z², respectively; the descriptions regarding A¹, A², and X for the compound represented by General Formula (I) described in JP2008-107767A can be referred to for A¹, A², and X, respectively; and the descriptions regarding Ax, Ay, and Q¹ for the compound represented by General Formula (I) described in WO 2013/018526A can be referred to for Ax, Ay, and Q², respectively. Reference can be made to the description on Q¹ for the compound (A) described in JP2012-21068A with regard to Z₃.

In particular, the organic groups represented by L₁ and L₂ are each preferably a group represented by -D³-G³-Sp-P³.

D³ has the same definition as in D¹.

G³ represents a single bond, a divalent aromatic ring group having 6 to 12 carbon atoms, a divalent heterocyclic group having 6 to 12 carbon atoms, or a divalent alicyclic hydrocarbon group having 5 to 8 carbon atoms, and a methylene group included in the alicyclic hydrocarbon group may be substituted with —O—, —S—, or —NR⁷—, in which R⁷ represents a hydrogen atom or an alkyl group having 1 to 6 carbon atoms.

Sp represents a single bond or a spacer group represented by —(CH₂)ₙ—, —(CH₂)ₙ—O—, —(CH₂—O—)ₙ—, —(CH₂CH₂—O—)ₘ, —O—(CH₂)ₙ—, —O—(CH₂)ₙ—O—, —O—(CH₂—O—)ₙ—, —O—(CH₂CH₂—O—)ₘ, —C(═O)—O—(CH₂)ₙ—, —C(═O)—O—(CH₂)ₙ—O—, —C(═O)—O—(CH₂—O—)ₙ—, —C(═O)—O—(CH₂CH₂—O—)ₘ, —C(═O)—N(R⁸)—(CH₂)ₙ—, —C(═O)—N(R⁸)—(CH₂)ₙ—O—, —C(═O)—N(R⁸)—(CH₂—O—)ₙ—, —C(═O)—N(R⁸)—(CH₂CH₂—O—)ₘ, or —(CH₂)ₙ—O—(C═O)—(CH₂)ₙ—C(═O)—O—(CH₂)ₙ—. Here, n represents an integer of 2 to 12, m represents an integer of 2 to 6, and R⁸ represents a hydrogen atom or an alkyl group having 1 to 6 carbon atoms. In addition, a hydrogen atom of —CH₂-in each group described above may be substituted with a methyl group.

P³ represents a polymerizable group.

The polymerizable group is not particularly limited, and is preferably a polymerizable group capable of radical polymerization or cationic polymerization.

Examples of the radically polymerizable group include known radically polymerizable groups, and an acryloyl group or a methacryloyl group is preferable. It has been known that an acryloyl group generally has a high polymerization rate, and from the viewpoint of improving productivity, an acryloyl group is preferable. However, a methacryloyl group can also be used as the polymerizable group for highly birefringent liquid crystals.

Examples of the cationically polymerizable group include known cationically polymerizable groups, and examples thereof include an alicyclic ether group, a cyclic acetal group, a cyclic lactone group, a cyclic thioether group, a spiro orthoester group, and a vinyloxy group. Among these, an alicyclic ether group or a vinyloxy group is preferable, and an epoxy group, an oxetanyl group, or a vinyloxy group is more preferable.

As described above, the liquid crystal lens 34 includes the substrate 50, the alignment film 52, and the above-described liquid crystal layer 36.

As the substrate 50 constituting the liquid crystal lens 34, various sheet-like materials can be used as long as they can support the alignment film 52 and the liquid crystal layer 36 described later.

As the substrate 50, a transparent substrate is preferable; and examples thereof include a polyacrylic resin film such as polymethyl methacrylate, a cellulose-based resin film such as cellulose triacetate, a cycloolefin polymer-based film, polyethylene terephthalate (PET), polycarbonate, and polyvinyl chloride. Examples of a commercially available product of the cycloolefin polymer-based film include trade name “ARTON” manufactured by JSR Corporation and trade name “ZEONOR” manufactured by Nippon Zeon Corporation. In addition, as the substrate 50, a glass substrate can also be suitably used.

The alignment film 52 is formed on the surface of the substrate 50.

The liquid crystal alignment pattern in the liquid crystal layer 36 follows the alignment pattern formed on the alignment film 52. Accordingly, the same alignment pattern as the liquid crystal alignment pattern in the liquid crystal layer 36 is formed in the alignment film 52 for forming the liquid crystal layer having the liquid crystal alignment pattern.

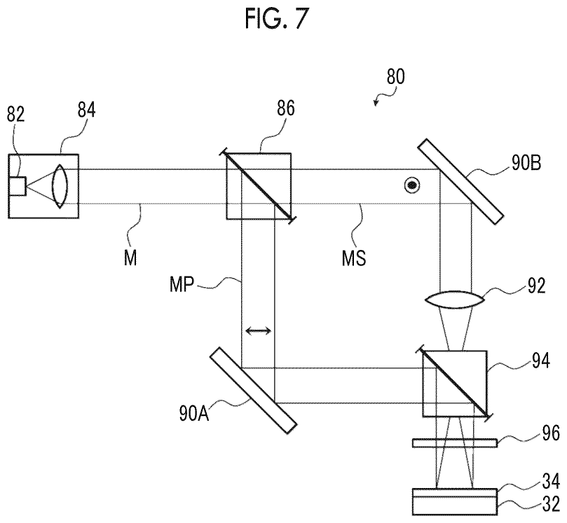

FIG. 7 conceptually shows an example of an exposure device in which the coating film serving as the alignment film 52 (photo-alignment film) for forming the liquid crystal layer 36 is exposed to form an alignment pattern corresponding to the concentric circular liquid crystal alignment pattern in which the optical axis changes while continuously rotating in a radial shape.

An exposure device 80 shown in FIG. 7 includes a light source 84 which includes a laser 82, a polarization beam splitter 86 which splits a laser light M emitted from the laser 82 into an S-polarized light MS and a P-polarized light MP, a mirror 90A which is disposed on an optical path of the P-polarized light MP and a mirror 90B which is disposed on an optical path of the S-polarized light MS, a lens 92 which is disposed on the optical path of the S-polarized light MS, a beam splitter 94, and a quarter plate 96.

The P-polarized light MP which is split by the polarization beam splitter 86 is reflected from the mirror 90A to be incident into the beam splitter 94. On the other hand, the S-polarized light MS which is split by the polarization beam splitter 86 is reflected from the mirror 90B and is focused by the lens 92 to be incident into the beam splitter 94.

The P-polarized light MP and the S-polarized light MS are combined by the beam splitter 94, are converted into dextrorotatory circularly polarized light and levorotatory circularly polarized light by the quarter plate 96 depending on the polarization direction, and are incident into the alignment film 52 on the substrate 50.

Due to interference between the dextrorotatory circularly polarized light and the levorotatory circularly polarized light, the polarization state of light with which the alignment film 52 is irradiated periodically changes according to interference fringes. An intersecting angle between dextrorotatory circularly polarized light and levorotatory circularly polarized light changes from the inside to the outside of the concentric circle, so that an exposure pattern in which the pitch (single period) gradually decreases from the inner side toward the outer side can be obtained. Accordingly, a concentric (radial) alignment pattern in which the alignment states periodically change is obtained in the alignment film 52.

In the exposure device 80, the single period Λ of the liquid crystal alignment pattern in which the optical axis of the liquid crystal compound 38 continuously rotates by 180° in the one direction can be controlled by changing a focal power of the lens 92, the focal length of the lens 92, the distance between the lens 92 and the alignment film 52, and the like.

In addition, by adjusting the focal power (F number) of the lens 92, the length of the single period of the liquid crystal alignment pattern in which the optical axis continuously rotates in the one direction can be changed.

Specifically, the length of the single period in the liquid crystal alignment pattern in which the optical axis continuously rotates in the one direction can be changed depending on a light spread angle at which light is spread by the lens 92 due to interference with parallel light. More specifically, in a case where the focal power of the lens 92 is decreased, the light is close to the parallel light, so that the length A of the single period in the liquid crystal alignment pattern is gradually decreased from the inner side toward the outer side. Conversely, in a case where the focal power of the lens 92 is stronger, the length A of the single period in the liquid crystal alignment pattern rapidly decreases from the inner side toward the outer side.

That is, by adjusting the refractive index of the lens 92, the refractive index of the liquid crystal lens 34 (liquid crystal layer 36) can be adjusted to act as a concave lens or a convex lens depending on the turning direction of the incident circularly polarized light.

The liquid crystal composition containing the liquid crystal compound, for forming the above-described liquid crystal layer 36, is applied onto the exposed alignment film 52 formed in this way, dried, and further cured by ultraviolet irradiation or the like as necessary.

As a result, the liquid crystal layer 36 having the concentric circular liquid crystal alignment pattern as described above, in which the single period gradually decreases from the center toward the outer direction, can be formed, and the liquid crystal lens 34 as shown in FIGS. 2 and 3 can be produced.

Preferable examples of the compound having a photo-aligned group, that is, a photo-alignment material used in a photo-alignment film include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking ester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking ester, a cinnamate compound, or a chalcone compound is suitably used.

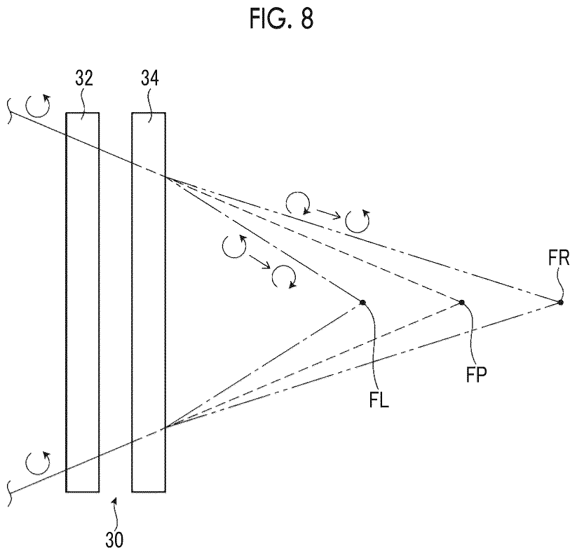

Hereinafter, the display apparatus 10 will be described in more detail by describing the action of the optical device 30 with reference to the conceptual diagram of FIG. 8.

As described above, the image emitted from the light-converging optical system of the display apparatus 10, including the half mirror 16, the lens 18, the circularly polarized light reflective polarizer 24, and the circular polarization plate 26, is the image of levorotatory circularly polarized light.

In addition, the image of levorotatory circularly polarized light is incident on the optical device 30, that is, the switching element 32 and the liquid crystal lens 34 in a state of being collected by the light-converging optical system (lens 18).

In the optical device 30, the switching element 32 is an element which switches between an off state in which the phase difference is zero and an on state in which the phase difference is a half wavelength so as to act as a half waveplate.

In addition, as an example, the liquid crystal lens 34 (liquid crystal layer 36) acts as a convex lens to converge light with respect to the levorotatory circularly polarized light and acts as a concave lens to diverge light with respect to the dextrorotatory circularly polarized light. The present invention is not limited thereto, and the liquid crystal lens 34 (liquid crystal layer 36) may diverge the levorotatory circularly polarized light and converge the dextrorotatory circularly polarized light.

In FIG. 8, a state of collecting the image of levorotatory circularly polarized light by the light-converging optical system consisting of the half mirror 16, the lens 18, the circularly polarized light reflective polarizer 24, and the circular polarization plate 26 is indicated by a broken line. In addition, a focal point thereof, that is, a focal point of the lens 18 is denoted by FO.

The image emitted from the light-converging optical system (circular polarization plate 26) is the image of levorotatory circularly polarized light.

Therefore, in a case where the switching element 32 is in the off state, the image of levorotatory circularly polarized light is transmitted through the switching element 32 as it is and is incident on the liquid crystal lens 34 as the levorotatory circularly polarized light.

The liquid crystal lens 34 (liquid crystal layer 36) converges the levorotatory circularly polarized light and diverges the dextrorotatory circularly polarized light.

Therefore, in this state, as indicated by a one-dot chain line in FIG. 8, the image of levorotatory circularly polarized light, incident on the liquid crystal lens 34 in a state of being collected by the light-converging optical system, is further collected by the liquid crystal lens 34 and is converted into the dextrorotatory circularly polarized light. As a result, the image of dextrorotatory circularly polarized light is collected at a focal point FL having a shorter focal length than the focal point FP.

On the other hand, in a case where the switching element 32 is in the on state, the image of levorotatory circularly polarized light is converted into the dextrorotatory circularly polarized light by the switching element 32 which acts as the half waveplate, and is incident on the liquid crystal lens 34.

The liquid crystal lens 34 (liquid crystal layer 36) converges the levorotatory circularly polarized light and diverges the dextrorotatory circularly polarized light.

Therefore, in this state, as indicated by a two-dot chain line in FIG. 8, the image of dextrorotatory circularly polarized light, incident on the liquid crystal lens 34 in a state of being collected by the light-converging optical system, is diverged to maintain the collection state by the liquid crystal lens 34, and is converted into the levorotatory circularly polarized light. That is, as indicated by the two-dot chain line in FIG. 8, the image of dextrorotatory circularly polarized light, incident on the liquid crystal lens 34 in a state of being collected by the light-converging optical system, is weakened in the degree of collection by the liquid crystal lens 34, and is converted into the levorotatory circularly polarized light. As a result, the image of levorotatory circularly polarized light is collected at a focal point FR having a longer focal length than the focal point FP.

As described above, the display apparatus 10 using the optical device according to the embodiment of the present invention can change the focal length of the image observed by the user O by switching the phase difference using the switching element 32, and can change the sense of depth of the virtual reality image.

Here, the display apparatus 10 using the optical device 30 according to the embodiment of the present invention can display (project) an image having stable image quality regardless of the focal point even in a case where the focal point of the image observed by the user O is changed.

As disclosed in U.S. Pat. No. 10,379,419B, by using the switchable half waveplate (SHWP) and the liquid crystal lens, the focal length of the observation image in the HMD can be switched.

However, according to the studies of the present inventors, in the HMD in the related art, in a case where the focal length is switched by using the switchable half waveplate and the liquid crystal lens, an appropriate image can be displayed at a certain focal length; but as the focal length is changed, an increase in ghost occurs due to leakage light or the like, and in a case of a full color image, a problem occurs in which the image quality of any of the red image, the green image, or the blue image is deteriorated, and thus the image quality is unstable depending on the focal length.

On the other hand, with the optical device 30 according to the embodiment of the present invention, in the optical device including the switching element having a switchable phase difference and the liquid crystal layer, the liquid crystal layer 36 formed of the liquid crystal composition containing the liquid crystal compound having reverse wavelength dispersibility is used. That is, the optical device according to the embodiment of the present invention includes the liquid crystal layer 36 formed of the liquid crystal composition containing the liquid crystal compound having reverse wavelength dispersibility.

Therefore, as will be described in Examples later, with the optical device according to the embodiment of the present invention, the change in image quality in a case where the focal length is switched in the HMD or the like is small, and any of the red image, the green image, or the blue image can achieve stable image quality regardless of the focal length.

In addition, in a case where the focal length of the HMD or the like is changed by using the optical device according to the embodiment of the present invention, the light in the collected state may be slightly collected or diverged.

In the example shown in FIGS. 1 and 8, the display apparatus 10 includes only one optical device 30 according to the embodiment of the present invention, but the present invention is not limited thereto.

That is, the display apparatus such as the HMD, using the optical device according to the embodiment of the present invention, may include a plurality of the optical devices 30 according to the embodiment of the present invention, consisting of the switching element and the liquid crystal layer.

In addition, in a case where the display apparatus includes a plurality of the optical devices 30, it is preferable that at least one liquid crystal layer 36 of the optical devices has a single period Λ different from those of the liquid crystal layers 36 of the other optical devices 30. Furthermore, in a case where the display apparatus includes a plurality of the optical devices 30, it is more preferable that all single periods A of the liquid crystal layers 36 of the optical devices are different from each other.

As shown in FIGS. 1 and 8, in a case where the display apparatus includes only one optical device 30, the focal length can be switched between two states. On the other hand, in a case where the display apparatus includes a plurality of the optical devices 30, the focal length of the display apparatus can be switched among three or more states, depending on the number of the optical devices 30.

In particular, by making the single period Λ of the liquid crystal layer 36 of the optical device 30 different, the focal length of the display apparatus can be switched among a larger number of states.

For example, in a case where the display apparatus includes two optical devices of a first optical device and a second optical device, and the single periods A of the liquid crystal layers of both optical devices are equal, three types of focal lengths of first device: on/second device: on, first device: off/second device: off, and first device: on/second device: off are possible as the focal length. The on/off of each device here means on/off of the switching element of the optical device described above. In this case, the focal lengths of first device: on/second device: off and first device: off/second device: on are the same.

On the other hand, in a case where the display apparatus includes two optical devices of a first optical device and a second optical device, and the single periods A of the liquid crystal layers of both optical devices are different, four types of focal lengths of first device: on/second device: on, first device: off/second device: off, first device: on/second device: off, and first device: off/second device: on are possible as the focal length. In addition, in this case, by providing three or more optical devices, a larger number of focal lengths can be switched by switching each device between the on state and the off state.

In the display apparatus 10 shown in FIG. 1, as a preferred aspect, the optical device according to the embodiment of the present invention is disposed downstream of the light-converging optical system.

However, the present invention is not limited thereto, and the optical device according to the embodiment of the present invention may be disposed upstream of the light-converging optical system or may be disposed in the light-converging optical system. However, in this configuration, there is a possibility that it is necessary to add a quarter waveplate for converting the circularly polarized light emitted from the light-converging optical system into a predetermined turning direction, and thus the control of the focal length is complicated.

In addition, the liquid crystal layer shown in FIG. 2 has the concentric circular liquid crystal alignment pattern, but the present invention is not limited thereto, and various liquid crystal alignment patterns can be used.

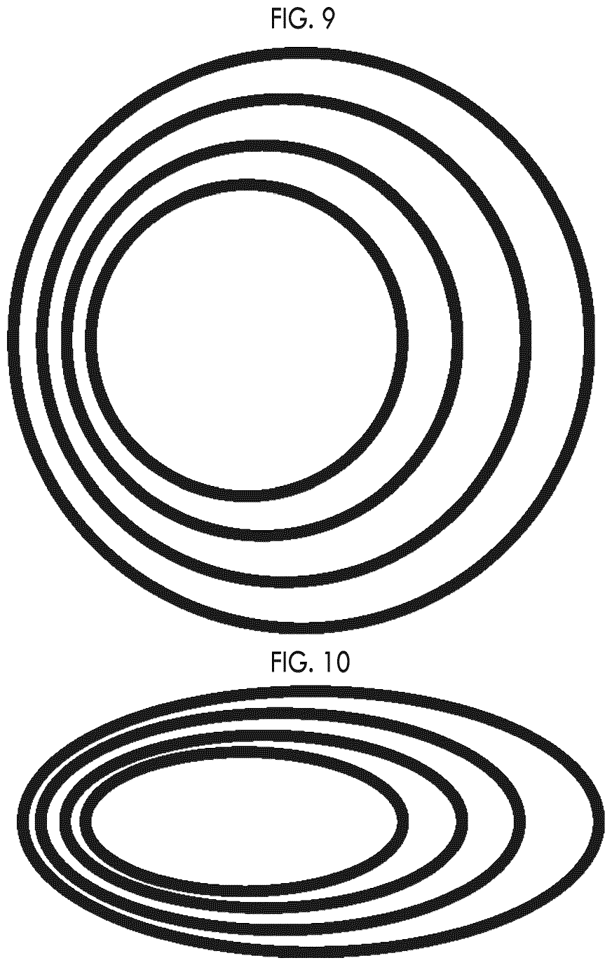

As an example, a liquid crystal alignment pattern in which circular patterns having different sizes are arranged such that large circles sequentially encompass smaller circles and centers of the circles are offset from one another, as conceptually shown in FIG. 9, is exemplified. In addition, the liquid crystal alignment pattern is not limited to the circular shape, and may be an elliptical or oval pattern as conceptually shown in FIG. 10.

That is, in the present invention, various liquid crystal alignment patterns having a plurality of rings having different sizes, which are arranged in the plane such that larger rings successively encompass smaller rings, can be used. In the present invention, the term “ring” refers to a shape having no end part, such as a circular shape, an elliptical shape, and a quadrangular shape.

Furthermore, in the present invention, the liquid crystal alignment pattern in the liquid crystal layer is not limited to the pattern having a plurality of rings, and may be, for example, a linear liquid crystal alignment pattern in which the orientation of the optical axis derived from the liquid crystal compound continuously changes in only one direction as shown in FIG. 4.

The liquid crystal layer having the linear liquid crystal alignment pattern refracts the circularly polarized light in the rotation direction of the optical axis, that is, the arrow A direction or the direction opposite to the arrow A direction, as shown in FIGS. 5 and 6, depending on the turning direction of the incident circularly polarized light. That is, by using the liquid crystal layer having the linear liquid crystal alignment pattern, the traveling direction of the light can be changed to two (two or more). For example, by using the optical device including such a liquid crystal layer in the image display apparatus, the display position of the image can be changed.

Such a linear liquid crystal alignment pattern can be formed, for example, by exposing the alignment film 52 using an exposure device shown in FIG. 7 of JP2022-36995A.

It is preferable that the various liquid crystal alignment patterns also have a region where the single period varies in the plane, as in the concentric circular liquid crystal alignment pattern.

The number of optical devices included in the display apparatus, the position of the optical device, and the liquid crystal alignment pattern of the liquid crystal layer included in the optical device described above are the same as those in AR glasses and the like described below.

The above examples are examples in which the optical device 30 according to the embodiment of the present invention is used in the VR image display apparatus 10 as the HMD, but the present invention is not limited thereto.

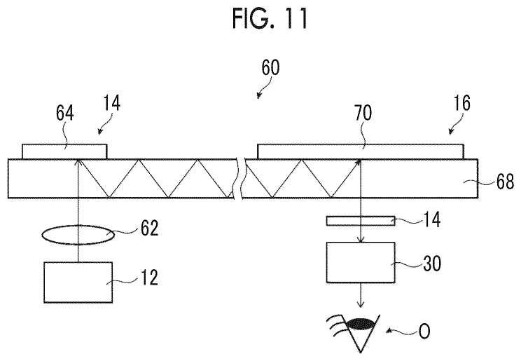

As an example, the optical device 30 according to the embodiment of the present invention can also be used in an AR image display apparatus (AR glasses) which is the HMD. FIG. 11 conceptually shows an example thereof.

AR glasses 60 shown in FIG. 11 use a plurality of the same members as the display apparatus 10 described above, so that the same reference numerals are assigned to the same members, and the description will be mainly made for different parts.

The AR glasses 60 shown in FIG. 11 are mounted on eyeglasses or the like, and are configured to allow the user O to observe a so-called augmented reality (AR) in which the image displayed on the display 12 is superimposed on a background.

In the AR glasses 60, the image displayed on the display 12 is converged by a lens 62, and is transmitted through a light guide plate 68 to be incident on an incident diffraction element 64.

The incident diffraction element 64 is a reflective diffraction element which diffracts and reflects the image transmitted through the light guide plate 68 to be incident on the light guide plate 68 at an angle at which the image is totally reflected and propagates in the light guide plate 68.

The image propagating in the light guide plate 68 is incident on an exit diffraction element 70. The exit diffraction element 70 is a reflective diffraction element that diffracts and reflects the image which is totally reflected and propagates in the light guide plate 68 to be emitted from the light guide plate 68.

Various known lenses (converging lens) and light guide plates used in the AR glasses can be used as the lens 62 and the light guide plate 68.

Various known reflective diffraction elements (diffraction gratings) such as a surface-relief diffraction element, a holographic diffraction element, and a reflective liquid crystal diffraction element can also be used as the incident diffraction element 64 and the exit diffraction element 70. In the AR glasses 60 of the example shown in the drawing, the image is incident on and emitted from the light guide plate 68 using the reflective diffraction element, but the present invention is not limited thereto, and the image may be incident on and emitted from the light guide plate 68 using a transmissive diffraction element. In this case, a known diffraction element such as a transmissive liquid crystal diffraction element can be used as the transmissive diffraction element.

The image emitted from the light guide plate 68 is converted into, for example, levorotatory circularly polarized light by the circular polarization plate 14, and is incident on the above-described optical device 30 according to the embodiment of the present invention.

As described with reference to FIG. 8, also in the AR glasses 60, the image is collected at the focal point FL having a short focal length by switching the switching element 32 of the optical device 30 in the off state and causing the levorotatory circularly polarized light to be incident on the liquid crystal lens 34 (liquid crystal layer 36) while remaining the levorotatory circularly polarized light. In addition, the image is collected at the focal point FR having a long focal length by switching the switching element 32 of the optical device 30 in the on state and causing the levorotatory circularly polarized light to be converted into the dextrorotatory circularly polarized light and then to be incident on the liquid crystal lens 34.

Even in this case, with the AR glasses using the optical device 30 according to the embodiment of the present invention, the change in image quality in a case where the focal length is switched is small, and any of the red image, the green image, or the blue image can achieve stable image quality regardless of the focal length.

The above examples are examples in which the optical device according to the embodiment of the present invention is used in the VR image display apparatus and the AR glasses, but the present invention is not limited thereto. That is, the optical device according to the embodiment of the present invention can be used for various applications.

As an example, a handling apparatus which changes a traveling direction of electromagnetic waves in a communication application can be exemplified.

Hereinbefore, the optical device and the head mounted display according to the embodiments of the present invention have been described in detail, but the present invention is not limited to the above-described examples, and various improvements or modifications may be made within a range not departing from the scope of the present invention.

### EXAMPLES

Hereinafter, the characteristics of the present invention will be described in detail by Examples. Materials, chemicals, used amounts, material amounts, ratios, treatment details, treatment procedures, and the like shown in the following examples can be appropriately changed within a range not departing from the scope of the present invention. Therefore, the scope of the present invention should not be construed as being limited to the following specific examples.

<Production of liquid crystal layer (liquid crystal lens)>

### Comparative Example 1

### (Support)

A glass substrate was used as a support.

### (Formation of Alignment Film)

The following coating liquid for forming an alignment film was applied onto the support by spin coating. The support on which the coating film of the alignment film-forming coating liquid was formed was dried using a hot plate at 60° C. for 60 seconds. As a result, an alignment film was formed.

Alignment film-forming coating liquid

| | | |
|---|---|---|
| Material A for photo-alignment | 1.00 | part by mass |
| Water | 16.00 | parts by mass |
| Butoxyethanol | 42.00 | parts by mass |
| Propylene glycol monomethyl ether | 42.00 | parts by mass |

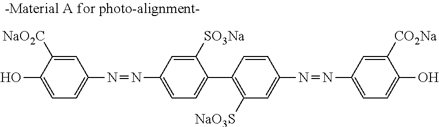

### (Exposure of Alignment Film)

The formed alignment film was exposed by the exposure device 80 shown in FIG. 7 to form an alignment film P-1 having an alignment pattern as shown in FIG. 2, in which a pattern where a short straight line (short line) continuously changes while rotating in one direction was provided in a concentric (radial) shape.

A single period Λ in the alignment pattern of the alignment film changed in a plane, and the minimum value thereof was 10 μm. The single period Λ of the alignment pattern was adjusted by a focal length of the lens 92 used in the exposure device 80 shown in FIG. 7.

A light source which emitted laser light having a wavelength of 355 nm was used. An exposure amount of the interference light was set to 1,000 mJ/cm².

### (Formation of Liquid Crystal Layer)

As a liquid crystal composition for forming a liquid crystal layer A-1, the following liquid crystal composition A-1 was prepared.

The following liquid crystal compound L-1 was a liquid crystal compound having forward wavelength dispersibility.

### Liquid Crystal Composition A-1

| | | |
|---|---|---|
| Liquid crystal compound L-1 | 100.00 | parts by mass |
| Polymerization initiator (manufactured by | 1.00 | part by mass |
| BASF, Irgacure OXE01) | | |
| Leveling agent T-1 | 0.08 | parts by mass |
| Methyl ethyl ketone | 1050.00 | parts by mass |

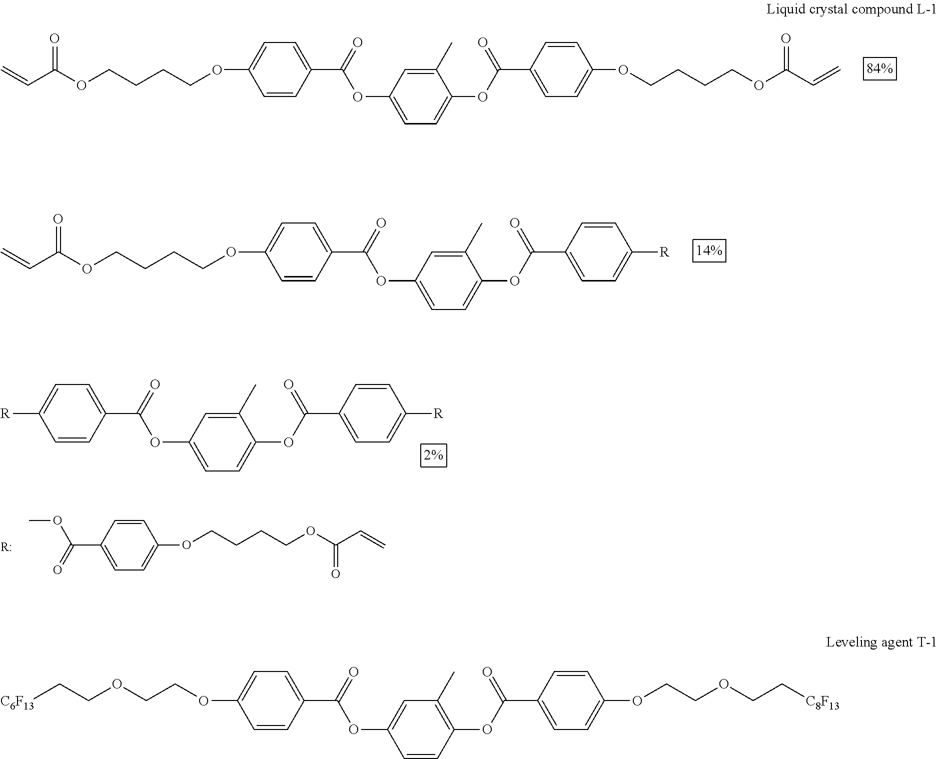

A liquid crystal layer was formed by applying the liquid crystal composition A-1 onto the alignment film P-1 in multiple layers.

The application in multiple layers refers to repetition of processes including producing a first liquid crystal immobilized layer by applying the first layer-forming liquid crystal composition A-1 onto the alignment film, heating the liquid crystal composition A-1, and irradiating the liquid crystal composition A-1 with ultraviolet light for curing; and producing a second or subsequent liquid crystal immobilized layer by applying the second or subsequent layer-forming liquid crystal composition A-1 onto the formed liquid crystal immobilized layer, heating the liquid crystal composition A-1, and irradiating the liquid crystal composition A-1 with ultraviolet light for curing as described above. Even in a case where the liquid crystal layer was formed by the application of the multiple layers such that the total thickness of the liquid crystal layer was large, the alignment direction of the alignment film was reflected from a lower surface of the liquid crystal layer to an upper surface thereof.

Regarding a first layer, the above-described liquid crystal composition A-1 was applied onto the alignment film P-1 to form a coating film, the coating film was heated to 80° C. on a hot plate, the coating film was irradiated with ultraviolet rays having a wavelength of 365 nm at an irradiation amount of 300 mJ/cm² using a high-pressure mercury lamp in a nitrogen atmosphere, thereby fixing the alignment of the liquid crystal compound.

Regarding the second or subsequent layer, the composition was applied onto the liquid crystal immobilized layer, and heated, and cured with ultraviolet rays under the same conditions as described above to produce a liquid crystal immobilized layer.

In this way, the overcoating was repeated until the total thickness reached the desired film thickness to produce a liquid crystal layer A-1 (transmissive liquid crystal lens (liquid crystal diffraction element)).

A difference Δn in refractive index of the cured layer of the liquid crystal composition A-1 was obtained by applying the liquid crystal composition A-1 onto a support with an alignment film for retardation measurement, which was prepared separately, aligning a director of the liquid crystal compound to be parallel to the substrate, irradiating the liquid crystal composition A-1 with ultraviolet rays for immobilization to obtain a liquid crystal immobilized layer (cured layer), and measuring a retardation value and a film thickness of the liquid crystal immobilized layer. An could be calculated by dividing the retardation value by the film thickness.

A retardation value was measured at a desired wavelength using Axoscan (manufactured by Axometrics, Inc.), and a film thickness was measured using a scanning electron microscope (SEM).

It was confirmed using a polarizing microscope that Δn₅₅₀×thickness (=Re(550)) of the liquid crystal layer A-1 was finally 275 nm and the liquid crystal layer A-1 had the concentric circular liquid crystal alignment pattern as shown in FIG. 2.

In the liquid crystal alignment pattern of the liquid crystal layer A-1, regarding a single period over which the optical axis of the liquid crystal compound rotated by 180°, a single period of a portion at a distance of approximately 10 mm from the center was 53 μm; a single period of a portion at a distance of 20 mm from the center was 27 μm; a single period of a portion at a distance of 25 mm from the center was 10.7 μm; and the single period decreased toward the outer direction.

In addition, in the liquid crystal layer A-1, a twisted angle of the liquid crystal compound in the thickness direction was 0° in the plane.

The obtained liquid crystal layer A-1 had a characteristic of diverging the incident light in a case where dextrorotatory circularly polarized light was incident, and a characteristic of converging the incident light in a case where levorotatory circularly polarized light was incident.

In addition, an effective diameter of the liquid crystal layer A-1 was 50 mm, and a focal power thereof was 2D.

### Comparative Example 2

As a liquid crystal composition for forming a first region of a liquid crystal layer B-1, a liquid crystal composition B-1 obtained by adding 0.33 parts by mass of the following chiral agent C-2 to the liquid crystal composition A-1 was obtained.

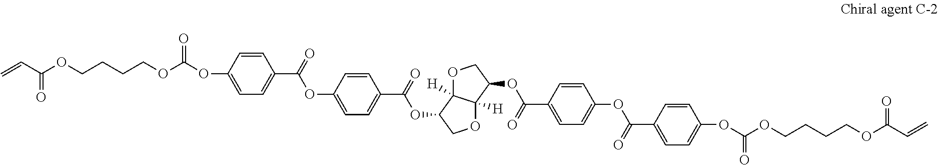 [SMILES: C=CC(=O)OCCCCOC(=O)Oc1ccc(C(=O)Oc2ccc(C(=O)O[C@H]3CO[C@H]4[C@@H]3OC[C@H]4OC(=O)c3ccc(OC(=O)c4ccc(OC(=O)OCCCCOC(=O)C=C)cc4)cc3)cc2)cc1]

The first region of the liquid crystal layer B-1 was formed in the same manner as in the liquid crystal layer A-2, except that the liquid crystal composition B-1 was used instead of the liquid crystal composition A-1 and the film thickness of the liquid crystal layer was adjusted.

It was confirmed using a polarizing microscope that Δn₅₅₀×thickness (=Re(550)) of the first region was finally 180 nm and the first region had the concentric circular liquid crystal alignment pattern as shown in FIG. 2.

In the liquid crystal alignment pattern of the first region, regarding a single period over which the optical axis of the liquid crystal compound rotated by 180°, a single period of a portion at a distance of approximately 10 mm from the center was 53 μm; a single period of a portion at a distance of 20 mm from the center was 27 μm; a single period of a portion at a distance of 25 mm from the center was 10.7 μm; and the single period decreased toward the outer direction.

In addition, in the first region, a twisted angle of the liquid crystal compound in the thickness direction was 80° in the plane.

Subsequently, a second region of the liquid crystal layer B-1 was formed on the first region of the liquid crystal layer B-1 in the same manner as above, except that the liquid crystal composition A-1 was used and the film thickness of the liquid crystal layer was adjusted.

It was confirmed using a polarizing microscope that Δn₅₅₀×thickness (=Re(550)) of the second region was finally 365 nm and the second region had the concentric circular liquid crystal alignment pattern as shown in FIG. 2.

In the liquid crystal alignment pattern of the second region, regarding a single period over which the optical axis of the liquid crystal compound rotated by 180°, a single period of a portion at a distance of approximately 10 mm from the center was 53 μm; a single period of a portion at a distance of 20 mm from the center was 27 μm; a single period of a portion at a distance of 25 mm from the center was 10.7 μm; and the single period decreased toward the outer direction.

In addition, in the second region of the liquid crystal layer B-1, a twisted angle of the liquid crystal compound in the thickness direction was 0° in the plane.

A liquid crystal composition C-1 was obtained by adding 0.54 parts by mass of the following chiral agent C-1 to the liquid crystal composition A-1.

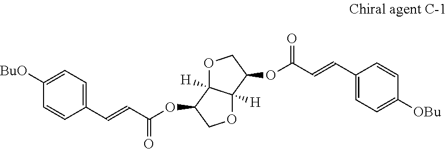

A third region of the liquid crystal layer was formed on the second region in the same manner as in the first region, except that the liquid crystal composition C-1 was used, thereby producing a liquid crystal layer B-1 (transmissive liquid crystal lens) consisting of the first region, the second region, and the third region.

It was confirmed using a polarizing microscope that Δn₅₅₀× thickness (=Re(550) of the third region was finally 180 nm and the third region had the concentric circular liquid crystal alignment pattern as shown in FIG. 2.

In the liquid crystal alignment pattern of the third region, regarding a single period over which the optical axis of the liquid crystal compound rotated by 180°, a single period of a portion at a distance of approximately 10 mm from the center was 53 μm; a single period of a portion at a distance of 20 mm from the center was 27 μm; a single period of a portion at a distance of 25 mm from the center was 10.7 μm; and the single period decreased toward the outer direction.

In addition, in the third region, a twisted angle of the liquid crystal compound in the thickness direction was −80° in the plane.

The obtained liquid crystal layer B-1 had a characteristic of diverging the incident light in a case where dextrorotatory circularly polarized light was incident, and a characteristic of converging the incident light in a case where levorotatory circularly polarized light was incident.

In addition, an effective diameter of the liquid crystal layer B-1 was 50 mm, and a focal power thereof was 2D.

### Example 1

A liquid crystal composition A-2 was prepared in the same manner as in the liquid crystal composition A-1, except that, in the liquid crystal composition A-1, the liquid crystal compound L-1 was changed to a liquid crystal compound L-2 and 0.02 parts by mass of the chiral agent C-2 was added.

The liquid crystal compound L-2 was a liquid crystal compound having reverse wavelength dispersibility.

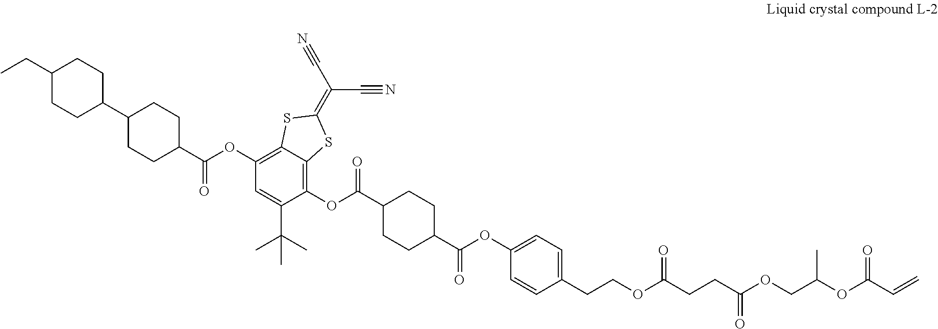 [SMILES: C=CC(=O)OC(C)COC(=O)CCC(=O)OCCc1ccc(OC(=O)C2CCC(C(=O)Oc3c(C(C)(C)C)cc(OC(=O)C4CCC(C5CCC(CC)CC5)CC4)c4c3SC(=C(C#N)C#N)S4)CC2)cc1]

A liquid crystal layer A-2 (transmissive liquid crystal lens) was produced in the same manner as in the liquid crystal layer A-1, except that the liquid crystal composition A-2 was used instead of the liquid crystal composition A-1.

It was confirmed using a polarizing microscope that Δn₅₅₀×thickness (=Re(550)) of the liquid crystal layer A-2 was finally 275 nm and the liquid crystal layer A-2 had the concentric circular liquid crystal alignment pattern as shown in FIG. 2.

In the liquid crystal alignment pattern of the liquid crystal layer A-2, regarding a single period over which the optical axis of the liquid crystal compound rotated by 180°, a single period of a portion at a distance of approximately 10 mm from the center was 53 μm; a single period of a portion at a distance of 20 mm from the center was 27 μm; a single period of a portion at a distance of 25 mm from the center was 10.7 μm; and the single period decreased toward the outer direction.

In addition, in the liquid crystal layer A-2, a twisted angle of the liquid crystal compound in the thickness direction was 7° in the plane.

The obtained liquid crystal layer A-2 had a characteristic of diverging the incident light in a case where dextrorotatory circularly polarized light was incident, and a characteristic of converging the incident light in a case where levorotatory circularly polarized light was incident.

In addition, an effective diameter of the liquid crystal layer A-2 was 50 mm, and a focal power thereof was 2D.

### Example 1-2

A liquid crystal layer A-3 (transmissive liquid crystal lens) was produced in the same manner as in the liquid crystal layer A-2, except that the focal length of the lens 92 in the exposure device 80 shown in FIG. 7 was adjusted in the exposure of the alignment film.

In the liquid crystal alignment pattern of the liquid crystal layer A-3, regarding a single period over which the optical axis of the liquid crystal compound rotated by 180°, a single period of a portion at a distance of approximately 10 mm from the center was 107 μm; a single period of a portion at a distance of 20 mm from the center was 53 μm; a single period of a portion at a distance of 25 mm from the center was 21.3 μm; and the single period decreased toward the outer direction.

An effective diameter of the liquid crystal layer A-3 was 50 mm, and a focal power thereof was 1D.

### Example 1-3

A liquid crystal layer A-4 (transmissive liquid crystal lens) was produced in the same manner as in the liquid crystal layer A-2, except that the focal length of the lens 92 in the exposure device 80 shown in FIG. 7 was adjusted in the exposure of the alignment film.

In the liquid crystal alignment pattern of the liquid crystal layer A-4, regarding a single period over which the optical axis of the liquid crystal compound rotated by 180°, a single period of a portion at a distance of approximately 10 mm from the center was 213 μm; a single period of a portion at a distance of 20 mm from the center was 107 μm; a single period of a portion at a distance of 25 mm from the center was 42.6 μm; and the single period decreased toward the outer direction.

An effective diameter of the liquid crystal layer A-4 was 50 mm, and a focal power thereof was 0.5 D.

### Example 1-4

A liquid crystal layer A-5 (transmissive liquid crystal lens) was produced in the same manner as in the liquid crystal layer A-2, except that the focal length of the lens 92 in the exposure device 80 shown in FIG. 7 was adjusted in the exposure of the alignment film.

In the liquid crystal alignment pattern of the liquid crystal layer A-5, regarding a single period over which the optical axis of the liquid crystal compound rotated by 180°, a single period of a portion at a distance of approximately 10 mm from the center was 426 μm; a single period of a portion at a distance of 20 mm from the center was 213 μm; a single period of a portion at a distance of 25 mm from the center was 85 μm; and the single period decreased toward the outer direction.

An effective diameter of the liquid crystal layer A-5 was 50 mm, and a focal power thereof was 0.25 D.

### Example 2

A liquid crystal composition A-6 was prepared in the same manner as in the liquid crystal composition A-2, except that the liquid crystal compound L-1 was changed to a liquid crystal compound L-3.

The liquid crystal compound L-3 was a liquid crystal compound having reverse wavelength dispersibility.

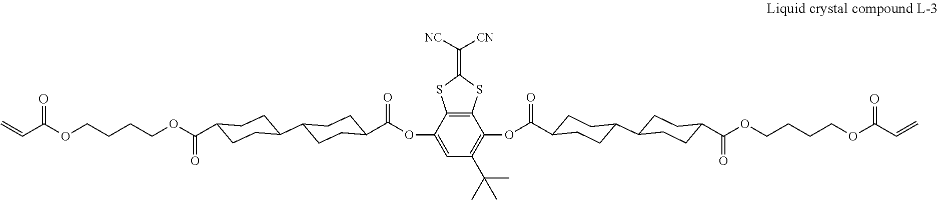 [SMILES: C=CC(=O)OCCCCOC(=O)C1CCC(C2CCC(C(=O)Oc3cc(C(C)(C)C)c(OC(=O)C4CCC(C5CCC(C(=O)OCCCCOC(=O)C=C)CC5)CC4)c4c3SC(=C(C#N)C#N)S4)CC2)CC1]

A liquid crystal layer A-6 (transmissive liquid crystal lens) was produced in the same manner as in the liquid crystal layer A-2, except that the liquid crystal composition A-6 was used instead of the liquid crystal composition A-2.

In the liquid crystal layer A-6, a twisted angle of the liquid crystal compound in the thickness direction was 7° in the plane.

### Example 3

As a liquid crystal composition for forming a liquid crystal layer A-7, the following liquid crystal composition A-7 was prepared.

The following liquid crystal compounds L-3 and L-4 were liquid crystal compounds having reverse wavelength dispersibility and the liquid crystal compounds L-1 and L-5 were liquid crystal compounds having forward wavelength dispersibility, but the composition as a whole exhibited reverse wavelength dispersibility.

### Liquid Crystal Composition A-7

| | | |
|---|---|---|
| Liquid crystal compound L-1 | 10.34 | parts by mass |
| Liquid crystal compound L-3 | 43.10 | parts by mass |
| Liquid crystal compound L-4 | 20.75 | parts by mass |
| Liquid crystal compound L-5 | 4.95 | parts by mass |
| Polymerization initiator (manufactured by | 1.00 | part by mass |
| BASF, Irgacure OXE01) | | |
| Leveling agent T-1 | 0.08 | parts by mass |
| Methyl ethyl ketone | 805.00 | parts by mass |
| Cyclopentanone | 245.00 | parts by mass |

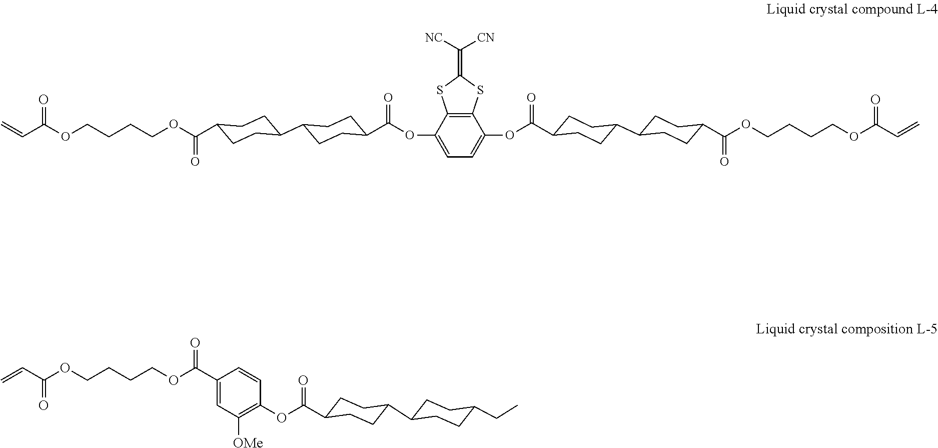

A liquid crystal layer A-7 (transmissive liquid crystal lens) was produced in the same manner as in the liquid crystal layer A-2, except that the liquid crystal composition A-7 was used instead of the liquid crystal composition A-2.

In the liquid crystal layer A-7, a twisted angle of the liquid crystal compound in the thickness direction was 7° in the plane.

### Example 4

A liquid crystal layer A-8 (transmissive liquid crystal lens) was produced in the same manner as in the liquid crystal layer A-2, except that the thickness of the liquid crystal layer A-2 was changed to finally set Δn₅₅₀× thickness (=Re(550)) of the liquid crystal to 300 nm.

In the liquid crystal layer A-8, a twisted angle of the liquid crystal compound in the thickness direction was 7° in the plane.

### (Evaluation of Liquid Crystal Layer)

The produced liquid crystal layer (liquid crystal lens) was evaluated according to the following standard.

In a case where a length over which the orientation of the optical axis derived from the liquid crystal compound rotated by 180° in one direction in which the orientation of the optical axis of the liquid crystal compound changed while continuously rotating was set as a single period, a position at which a length of the single period was 40 μm was used as an evaluation coordinate.

Laser light of blue (450 nm), green (532 nm), and red (650 nm) was incident on the liquid crystal layer at an oblique angle of 40° at the evaluation coordinate. The laser light was made to be circularly polarized by being perpendicularly incident into a circular polarization plate corresponding to the wavelength of the laser light, and then dextrorotatory circularly polarized light and levorotatory circularly polarized light were incident into the produced liquid crystal diffraction element. For the six combinations of two conditions of the levorotatory circularly polarized light and the dextrorotatory circularly polarized light and three conditions of the wavelength of the incident light, the maximum value of zero-order leakage light (maximum transmittance of the straight-ahead component) of the light transmitted through the liquid crystal diffraction element without diffraction was used as an evaluation value.
A+: maximum value of zero-order leakage light was less than 1.6%.
A: maximum value of zero-order leakage light was 1.6% or more and less than 2%.
B: maximum value of zero-order leakage light was 2% or more and less than 5%.
C: maximum value of zero-order leakage light was 5% or more and less than 8%.
D: maximum value of zero-order leakage light was 8% or more.

The results are shown in Table 1.

In addition, Table 1 also shows Δn(550) of the liquid crystal layer at 550 nm, dispersibility on the short wavelength side, dispersibility on the long wavelength side, the minimum single period (minimum pitch width) in the liquid crystal alignment pattern, and the focal power.

TABLE 1

| | | Example | Example | Example | | | | Comparative | Comparative |
|---|---|---|---|---|---|---|---|---|---|
| | Example 1 | 1-2 | 1-3 | 1-4 | Example 2 | Example 3 | Example 4 | Example 1 | Example 2 |
| Liquid crystal | A-2 | A-3 | A-4 | A-5 | A-6 | A-7 | A-8 | A-1 | B-1 |
| layer | | | | | | | | | |
| Layer configuration | Monolayer | Monolayer | Monolayer | Monolayer | Monolayer | Monolayer | Monolayer | Three layers | Monolayer |
| Method of | Reverse | Reverse | Reverse | Reverse | Reverse | Reverse | Reverse | Forward | Forward |
| adjusting | wavelength | wavelength | wavelength | wavelength | wavelength | wavelength | wavelength | wavelength | wavelength |
| wavelength | dispersibility | dispersibility | dispersibility | dispersibility | dispersibility | dispersibility | dispersibility | dispersibility | dispersibility |
| dispersibility | | | | | | | | | |
| Δn(550) | 0.05 | 0.05 | 0.05 | 0.05 | 0.04 | 0.05 | 0.05 | 0.05 | 0.05 |
| Dispersibility on | 0.75 | 0.75 | 0.75 | 0.75 | 0.69 | 0.84 | 0.75 | 1.15 | 1.15 |
| short wavelength | | | | | | | | | |
| side | | | | | | | | | |
| Re(450 nm)/Re(550 | | | | | | | | | |
| nm) | | | | | | | | | |
| Dispersibility on | 1.06 | 1.06 | 1.06 | 1.06 | 1.08 | 1.03 | 1.06 | 0.96 | 0.96 |
| long wavelength | | | | | | | | | |
| side | | | | | | | | | |
| Re(650 nm)/Re(550 | | | | | | | | | |
| nm) | | | | | | | | | |
| Minimum pitch | 10.7 μm | 21.3 μm | 42.6 μm | 85 μm | 10.7 μm | 10.7 μm | 10.7 μm | 10.7 μm | 10.7 μm |
| width | | | | | | | | | |
| Focal power | 2D | 1D | 0.5D | 0.25D | 2D | 2D | 2D | 2D | 2D |
| Evaluation | A | A | A | A | B | B | A+ | D | D |

### <Production of Optical Device 101>

A liquid crystal cell in a VA mode was prepared as the switching element 51.

In the switching element, a phase difference of the liquid crystal cell in the voltage ON state was 275 nm, and a phase difference of the liquid crystal cell in the voltage OFF state was 5 nm or less. Both phase differences were phase differences at a wavelength of 550 nm.

In a case where dextrorotatory circularly polarized light was incident on the switching element in the voltage ON state, the transmitted light was levorotatory circularly polarized light; and in a case where dextrorotatory circularly polarized light was incident on the switching element in the voltage OFF state, the transmitted light was dextrorotatory circularly polarized light.

The liquid crystal layer A-2 was peeled off from the support and bonded to one surface of the switching element 51 through a pressure sensitive adhesive to obtain an optical device 101 including the switching element 51, the pressure sensitive adhesive, and the liquid crystal layer A-2 in this order.

In a case where dextrorotatory circularly polarized light was incident on the optical device 101 from the switching element 51 side, and the voltage of the switching element 51 was turned ON, the optical device 101 functioned as a converging lens having a focal power of 2D. In addition, in a case where the voltage of the switching element 51 was turned OFF, the optical device 101 functioned as a diverging lens having a focal power of −2D. It was confirmed that two types of focal powers could be switched by switching the voltage ON and OFF states of the switching element 51.

### <Production of Optical Devices 102 to 105>

Optical devices 102 to 105 were obtained in the same manner as in the optical device 101, except that the liquid crystal layer A-6, the liquid crystal layer A-7, and the liquid crystal layers A-1 and B-1 were used instead of the liquid crystal layer A-2.

### <Production of Optical Device 111>

The liquid crystal layer A-3 was peeled off from the support and bonded to one surface of the first switching element 51 through a pressure sensitive adhesive. In addition, a second switching element 51 was bonded to the other surface of the liquid crystal layer A-3 through a pressure sensitive adhesive. Furthermore, a second liquid crystal layer A-3 was bonded through a pressure sensitive adhesive.

In this way, an optical device 111 including the first switching element 51, the pressure sensitive adhesive, the first liquid crystal layer A-3, the pressure sensitive adhesive, the second switching element 51, the pressure sensitive adhesive, and the second liquid crystal layer A-3 in this order was obtained.

Since the optical device 111 includes the first and second switching elements 51, there are four types of voltage application states.

In a case where dextrorotatory circularly polarized light was incident on the optical device 111 from the first switching element 51 side, and the voltage of the first switching element was turned ON and the voltage of the second switching element was turned OFF, the optical device 111 functioned as a converging lens having a focal power of 2D. In addition, in a case where the voltage of the first switching element was turned OFF and the voltage of the second switching element was turned ON, the optical device 111 functioned as a diverging lens having a focal power of −2D.

Furthermore, in a case where the voltage of the first switching element was turned OFF and the voltage of the second switching element was turned ON, and in a case where the voltage of the first switching element was turned ON and the voltage of the second switching element was turned OFF, the focal power was 0, that is, the optical device 111 did not function as a lens.

From the above points, it was confirmed that the optical device 111 could switch three types of focal powers.

### <Production of Optical Device 112>

By repeating the same procedure as in the optical device 111, an optical device 112 including the first switching element 51, the pressure sensitive adhesive, the first liquid crystal layer A-3, the pressure sensitive adhesive, the second switching element 51, the pressure sensitive adhesive, the second liquid crystal layer A-4, the pressure sensitive adhesive, the third switching element 51, the pressure sensitive adhesive, and the third liquid crystal layer A-4 in this order was obtained.

Since the optical device 112 includes the first, second, and third switching elements 51, there are 8 types of voltage application states. It was confirmed that 5 types of focal powers of 2 D, 1 D, 0, −1 D, and −2 D could be switched by switching the voltage application state.

### <Production of Optical Device 113>

By repeating the same procedure as in the optical device 111, an optical device 113 including the first switching element 51, the pressure sensitive adhesive, the first liquid crystal layer A-3, the pressure sensitive adhesive, the second switching element 51, the pressure sensitive adhesive, the second liquid crystal layer A-4, the pressure sensitive adhesive, the third switching element 51, the pressure sensitive adhesive, the third liquid crystal layer A-5, the pressure sensitive adhesive, the fourth switching element 51, the pressure sensitive adhesive, and the fourth liquid crystal layer A-5 in this order was obtained.

Since the optical device 112 includes the first, second, third, and fourth switching elements 51, there are 16 types of voltage application states. It was confirmed that 9 types of focal powers of 2 D, 1.5 D, 1 D, 0.5 D, 0, −0.5 D, −1 D, −1.5 D, and −2 D could be switched by switching the voltage application state.

### <Production of Virtual Reality Image Display Apparatus>

A commercially available microdisplay (manufactured by SeeYA Technology, screen size: 0.49 inch) was prepared, and a plano-convex lens (manufactured by Thorlabs, Inc., LA1145-A) was disposed on the front surface thereof.

By viewing the microdisplay through the plano-convex lens, the observer could observe a virtual image of the image displayed on the microdisplay, and it was confirmed that the device functioned as a virtual reality image display apparatus.

By further disposing the optical devices 101 to 105 on the observer side of the plano-convex lens, virtual reality image display apparatuses 101 to 105 were obtained.

By switching the voltage application state, the position of the virtual image of the image displayed on the microdisplay could be switched.

In the virtual reality display apparatuses 101 to 105, ghost which was visually recognized in a case where the observer observed the virtual image of the image displayed on the microdisplay was compared. In the virtual reality display apparatuses 104 and 105, ghosting was clearly visible, whereas in the virtual reality display apparatuses 101 to 103 corresponding to the head mounted display (HMD) according to the embodiment of the present invention, only slight ghosting was observed, which was favorable.

In addition, in the virtual reality display apparatus 101, the ghosting was less visible than in the virtual reality display apparatuses 102 and 103, which was further favorable.

By further disposing the optical devices 111 to 113 on the observer side of the plano-convex lens, virtual reality image display apparatuses 111 to 113 corresponding to the HMD according to the embodiment of the present invention were obtained. It was confirmed that the position of the virtual image of the image displayed on the microdisplay could be switched in a plurality of stages by switching the voltage application state.

The present invention can be suitably used in the HMD of the VR image display apparatus or the like.

### EXPLANATION OF REFERENCES

10: (VR image) display apparatus
12: display
14, 26: circular polarization plate
14a: linear polarizer
14b: quarter waveplate
16: half mirror
18, 62: lens
24: circularly polarized light reflective polarizer
30: optical device
32: switching element
34: liquid crystal lens
36, 36A: liquid crystal layer
38: liquid crystal compound
50: substrate
52: alignment film
60: AR glass
64: incidence diffraction element
68: light guide plate
70: emission diffraction element

What is claimed is:

1. An optical device comprising:
a switching element; and
a liquid crystal layer,
wherein the switching element is an element which is configured to switch between a first phase difference and a second phase difference, and a difference between the first phase difference and the second phase difference is 275±20 nm at a wavelength of 550 nm, and
the liquid crystal layer is formed of a liquid crystal composition containing a liquid crystal compound having reverse wavelength dispersibility, and has a liquid crystal alignment pattern in which an orientation of an optical axis derived from the liquid crystal compound changes while continuously rotating in at least one in-plane direction.

2. The optical device according to claim 1,
wherein, in the liquid crystal alignment pattern, in a case where a length over which the orientation of the optical axis derived from the liquid crystal compound rotates by 180° in the plane is set as a single period, the liquid crystal alignment pattern has, in the plane, a region where a length of the single period varies.

3. The optical device according to claim 1,
wherein the liquid crystal alignment pattern has a plurality of rings having different sizes, which are arranged in the plane such that larger rings successively encompass smaller rings.

4. The optical device according to claim 3,
wherein the liquid crystal alignment pattern has a concentric circle shape.

5. The optical device according to claim 1,
wherein the switching element is composed of a liquid crystal cell.

6. A head mounted display comprising:
the optical device according to claim 1.

7. The head mounted display according to claim 6,
wherein the head mounted display is any one of a virtual reality image display apparatus or an augmented reality image display apparatus.

8. The head mounted display according to claim 7,
wherein the head mounted display is a virtual reality image display apparatus including a light-converging optical system, and the optical device is provided downstream of the light-converging optical system.

9. The head mounted display according to claim 7,
wherein the head mounted display is an augmented reality image display apparatus including a light guide plate, and the optical device is provided downstream of the light guide plate.

10. The optical device according to claim 2,
wherein the liquid crystal alignment pattern has a plurality of rings having different sizes, which are arranged in the plane such that larger rings successively encompass smaller rings.

11. The optical device according to claim 10,
wherein the liquid crystal alignment pattern has a concentric circle shape.

12. The optical device according to claim 2,
wherein the switching element is composed of a liquid crystal cell.

13. A head mounted display comprising:
the optical device according to claim 2.

14. The head mounted display according to claim 13,
wherein the head mounted display is any one of a virtual reality image display apparatus or an augmented reality image display apparatus.

15. The head mounted display according to claim 14,
wherein the head mounted display is a virtual reality image display apparatus including a light-converging optical system, and the optical device is provided downstream of the light-converging optical system.

16. The head mounted display according to claim 8,
wherein the head mounted display is an augmented reality image display apparatus including a light guide plate, and the optical device is provided downstream of the light guide plate.

17. The optical device according to claim 3,
wherein the switching element is composed of a liquid crystal cell.

18. A head mounted display comprising:
the optical device according to claim 3.

19. The head mounted display according to claim 18,
wherein the head mounted display is any one of a virtual reality image display apparatus or an augmented reality image display apparatus.

20. The head mounted display according to claim 19,
wherein the head mounted display is a virtual reality image display apparatus including a light-converging optical system, and the optical device is provided downstream of the light-converging optical system.
